(19) United States
(12) Patent Application Publication
(10) Pub. No.: US 2023/0123843 A1
(43) Pub. Date: Apr. 20, 2023

(54) COMPOSITE CATHODE, METHOD OF PREPARING THE SAME, AND SECONDARY BATTERY INCLUDING THE COMPOSITE CATHODE

(71) Applicant: Samsung Electronics Co., Ltd., Suwon-si (KR)

(72) Inventors: Youngjoon Bae, Seoul (KR); Taeyoung Kim, Seoul (KR); Sungjin Lim, Suwon-si (KR)

(21) Appl. No.: 17/897,484

(22) Filed: Aug. 29, 2022

(30) Foreign Application Priority Data
Sep. 24, 2021 (KR) 10-2021-0126543

(51) Int. Cl. H01M 4/58; H01M 4/36; H01M 4/62; H01M 10/0562; H01M 10/0585; H01M 4/04; H01M 4/136

(52) U.S. Cl. CPC H01M 4/5825; H01M 4/62; H01M 4/136; H01M 4/364; H01M 4/0471; H01M 10/0562; H01M 10/0585; H01M 2004/028

(57) ABSTRACT

A composite cathode, including: a cathode current collector; and a cathode active material layer on the cathode current collector. The cathode active material layer includes: a crystalline phosphate solid electrolyte; a crystalline phosphate cathode active material having an electrical conductivity about 10 times to about 10⁶ times greater than an electrical conductivity of the crystalline phosphate solid electrolyte; and an interphase between the crystalline phosphate solid electrolyte and the crystalline phosphate cathode active material.

### CROSS-REFERENCE TO RELATED APPLICATION

This application is based on and claims priority to Korean Patent Application No. 10-2021-0126543, filed on Sep. 24, 2021, in the Korean Intellectual Property Office, and all the benefits accruing therefrom under 35 U.S.C. §119, the content of which is incorporated by reference herein in its entirety.

### BACKGROUND

### 1. Field

The present disclosure relates to composite cathodes, methods of preparing the same, and secondary batteries including the composite cathodes.

### 2. Description of the Related Art

The development of all-solid-state batteries has been progressing remarkably in recent years due to safety issues of lithium-ion batteries.

For use as a solid electrolyte of an all-solid-state battery, an oxide-based solid electrolyte or a sulfide-based solid electrolyte may be used. An oxide-based solid electrolyte is more stable in the atmosphere than a sulfide-based solid electrolyte, and in this regard, many studies are in progress to commercialize oxide-based solid electrolytes.

However, oxide-based solid electrolytes have insufficient ductility, and thus interfacial resistance may increase when in contact with a cathode active material. When a conductive material is added to lower the increased interfacial resistance in preparing a cathode, while not wanting to bound by theory, formation of contact between a solid electrolyte and a cathode during heat treatment for the cathode preparation is disturbed, and consequently, a large number of pores are generated in a prepared cathode. Accordingly, the discharge capacity and the capacity retention rate are reduced. Therefore, there remains a need for improved solid electrolytes.

### SUMMARY

Provided is a composite cathode including a composite having improved electrochemical characteristics.

Provided is a secondary battery having improved initial capacity and cycle stability by including the composite cathode.

Provided is a method of preparing the composite cathode.

Additional aspects will be set forth in part in the description which follows and, in part, will be apparent from the description, or may be learned by practice of the presented embodiments of the disclosure.

According to an aspect of an embodiment, a composite cathode includes: a cathode current collector; and a cathode active material layer on the cathode current collector, wherein the cathode active material layer includes a composite including: a crystalline phosphate solid electrolyte; a crystalline phosphate cathode active material having an electrical conductivity that is about 10 times to about 10⁶ times greater than an electrical conductivity of the crystalline phosphate solid electrolyte; and an interphase between the crystalline phosphate solid electrolyte and the crystalline phosphate cathode active material.

According to another aspect of an embodiment, a secondary battery includes the composite cathode, an anode, and an electrolyte between the composite cathode and the anode.

In an embodiment, the secondary battery may be a lithium secondary battery or an all-solid-state battery. The all-solid-state battery may be, for example, a multilayer-ceramic (MLC) battery.

According to another aspect of an embodiment, a method of preparing a composite cathode includes: mixing a crystalline phosphate solid electrolyte, a crystalline phosphate cathode active material having an electrical conductivity about 10 times to about 10⁶ times greater than an electrical conductivity of the crystalline phosphate solid electrolyte, a binder, and a solvent to form a composition; and heat treating the composition at a temperature of 700° C. or greater and at a pressure of 150 megapascals or less to form the composite cathode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a scanning electron microscope (SEM) image of a composite cathode of Example 1;

FIG. 1B shows the results of energy dispersive X-ray spectroscopy (EDS) analysis of a composite cathode of Example 1;

FIGS. 2A to 2E show SEM images of composites of Comparative Examples 1 to 5, respectively;

FIG. 3A is a graph of intensity (arbitrary units, a.u.) vs. diffraction angle (degrees two-theta (2θ)) and shows the results of X-ray diffraction analysis of composites of Example 1 and Comparative Example 1;

FIGS. 3B1 and 3B2 are graphs of intensity (a.u.) vs. diffraction angle (degrees 2θ) and are enlarged views of a partial area of FIG. 3A;

FIG. 4A is a graph of intensity (a.u.) vs. diffraction angle (degrees 2θ) and shows the results of XRD analysis of a composite of Comparative Example 3;

FIGS. 4B1 and 4B2 are enlarged views of a partial area of FIG. 4A;

FIGS. 5A to 5D are graphs of voltage (Volts, V) vs. capacity (milliampere-hours per gram, mAh/g) and show changes in voltage according to capacity of lithium secondary batteries of Examples 1 and 2 and Comparative Examples 1 and 2, respectively;

FIGS. 5E to 5G are graphs of voltage (V) vs. capacity (mAh/g) and show changes in voltage according to capacity of lithium secondary batteries of Comparative Examples 3 to 5, respectively;

FIG. 6A is a graph of initial discharge capacity (mAh/g) vs. hot-press temperature (degree Celsius, °C) and FIG. 6B is a graph of capacity retention (percent, %) vs. hot-press temperature (°C), and respectively show changes in initial discharge capacity, and changes in capacity retention after 10 cycles of lithium secondary batteries, according to different hot press temperatures during preparation of a cathode;

FIG. 7 is an image schematically illustrating an embodiment of a structure of a multilayer-ceramic battery ;

FIGS. 8, 9A and 9B are each an image schematically illustrating an embodiment of a structure of a secondary battery;

FIG. 10 is an image schematically illustrating an embodiment of a structure of a secondary battery; and

FIGS. 11 to 13 are each a cross-sectional view of an embodiment of an all-solid-state secondary battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

Hereinafter, a composite according to an embodiment, a method of preparing the composite, a composite cathode including the composite, and a secondary battery including the composite cathode will be described in detail.

This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element’s relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” can mean within one or more standard deviations, or within ± 30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

When a composition in which a conductive material such as carbon (e.g., a carbonaceous electron conductor) is added to a cathode active material and a solid electrolyte is sintered at a high temperature in the preparation of a cathode for an all-solid-state battery, formation of contact between a solid electrolyte and a cathode may be disturbed, and consequently, a large number of pores may be generated in a cathode. In this regard, an all-solid-state battery including such a cathode may have problems in degradation in a discharge capacity and a capacity retention during a charge/discharge test.

To solve the problems, a method using only a solid electrolyte and a cathode active material without using a conductive material in the preparation of a cathode has been proposed. However, electrical conductivity of the solid electrolyte is so low that an electronic conduction pathway in the cathode is difficult to be formed.

The inventors of the present disclosure completed the present disclosure in a way that a composite and a composite cathode including the composite were used without using a conductive material to solve the above-described problems, wherein the composite includes: a crystalline phosphate-based solid electrolyte and a phosphate-based cathode active material having a high electrical conductivity that is about 10 times to about 10⁶ times greater than that of the crystalline phosphate-based solid electrolyte, and a composite cathode including the composite were used.

The electronic conductivity may be determined by an eddy current method or a kelvin bridge method. The electrical conductivity can be determined according to ASTM B-193, “Standard Test Method for Resistivity of Electrical Conductor Materials,” e.g., at 20° C., or according to ASTM E-1004, “Standard Test Method for Determining Electrical Conductivity Using the Electromagnetic (Eddy-Current) Method,” e.g., at 20° C. Additional details may be determined by one of skill in the art without undue experimentation.

The composite cathode according to an embodiment may include a composite including: a crystalline phosphate-based solid electrolyte; a crystalline phosphate-based cathode active material having an electrical conductivity that is about 10 times to about 10⁶ times greater than the electrical conductivity of the crystalline phosphate-based solid electrolyte; and an interphase therebetween.

When the electrical conductivity of the crystalline phosphate-based cathode active material is about 10 times to about 10⁶ times greater than the electrical conductivity of the crystalline phosphate-based solid electrolyte, the cathode active materials in the composite and the composite cathode including the composite may be connected to each other to form a matrix structure. In this regard, an electronic conduction path may be formed without using a conductive material, and accordingly, interphase between the solid electrolyte and the cathode may be easily formed, thereby having low interfacial resistance between the solid electrolyte and the cathode.

The composite may have a structure in which the solid electrolyte is uniformly dispersed in a cathode active material matrix.

The electrical conductivity of the crystalline phosphate-based cathode active material may be about 10 times to about 10⁴ times, about 10 times to about 10³ times, about 10 times to about 500 times, about 10 times to about 400 times, about 10 times to about 300 times, or about 15 times to about 250 times greater than that of the crystalline phosphate-based solid electrolyte.

The electrical conductivity of the crystalline phosphate-based cathode active material may be, for example, in a range of about 2 × 10⁻⁴ millisiemens per centimeter (mS/cm) to about 3 × 10⁻⁴ mS/cm, or may be about 2.4 × 10⁻⁴ mS/cm, and the electrical conductivity of the crystalline phosphate-based solid electrolyte may be in a range of about 1.44 × 10⁻⁵ mS/cm to about 1.1 × 10⁻⁶ mS/cm.

When the difference of the electrical conductivity of the crystalline phosphate-based cathode active material is within these ranges, an electronic conduction pathway may be smoothly formed in the composite cathode so that the cathode active materials may be connected to each other.

The interphase between the crystalline phosphate-based cathode active material and the crystalline phosphate-based solid electrolyte may be amorphous, and the state and composition of the amorphous interphase may be identified by energy dispersive X-ray spectroscopy (EDS) analysis and scanning electron microscopy (SEM) analysis. As such, in the presence of the amorphous interphase, the contact area between the cathode active material and the solid electrolyte is increased so that lithium ions may move smoothly between the cathode active material and the solid electrolyte, thereby improving battery performance.

The term “interphase” as used herein refers to a secondary phase between the crystalline phosphate-based solid electrolyte and the crystalline phosphate-based cathode active material that form a main phase (i.e., a primary phase). Here, the term “a secondary phase” means a minor phase having a smaller content than the main phase.

As a result of the EDS analysis, such an amorphous interphase may include at least one element which is also included in the crystalline phosphate-based solid electrolyte, the crystalline phosphate-based cathode active material, or a combination thereof.

In an embodiment, when a phosphate-based cathode active material e.g., Li₃V₂(PO₄)₃, (LVP) and a crystalline solid electrolyte, e.g., Li_{1.5}Al_{0.5}Ge_{1.5(}PO₄)₃, (LGAP) were used as the crystalline phosphate-based cathode active material and the crystalline phosphate-based solid electrolyte, respectively, the EDS analysis results show that the amorphous interphase may include, for example, aluminum (Al), vanadium (V), phosphorous (P), or oxygen (O), while not including germanium (Ge). Here, the EDS analysis does not evaluate the presence or absence of lithium.

The content of the amorphous interphase may be calculated from the volume occupied by the amorphous interphase per total volume of the composite as shown in the SEM analysis image. The volume of the amorphous interphase may be, for example, about 5 volume percent (vol%) or less, for example, about 0.1 vol% to about 5 vol%, about 0.2 vol% to about 4 vol%, about 2 vol% to about 3 vol%, based on the total volume of the composite. When the amorphous interphase is present at the above-described content, the electronic conduction pathway may be easily formed without using a separate conductive material in the composite.

The crystalline phosphate-based cathode active material may be a compound represented by Formula 1, a compound represented by Formula 2, or a combination thereof:

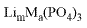

wherein, in Formula 1, M may be Ti, Si, Mn, Fe, Co, V, Cr, Mo, Ni, Al, Mg, Al, or a combination thereof, and 1≤m≤5 and 1≤a≤2;

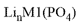

wherein, in Formula 2, M1 may be Co, Ni, Mn, Fe, or a combination thereof, and 1≤n≤1.5.

The compound represented by Formula 1 may be, for example, Li₃V_{[2-2x]/3}Mgₓ(PO₄)₃ (wherein x is between 0.15 and 0.6).

The compound represented by Formula 2 may be a compound represented by Formula 2-1:

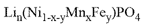

wherein, in Formula 2-1, 1≤n≤1.2, 0≤x≤1, 0≤y≤1, and 0≤x+y≤1.

The crystalline phosphate-based cathode active material may include Li₃V₂(PO₄)₃, LiCoPO₄, LiFePO₄, LiNiPO₄, LiMnPO₄, or a combination thereof.

In an embodiment, the crystalline phosphate-based solid electrolyte may be, for example, Li₁₊ₓAlₓGe₂₋ₓ(PO₄)₃ (0<x≤2), Li₁₊ₓAlₓTi₂₋ₓ(PO₄)₃ (0≤x≤1 ), Li_{i+x+y}AlₓTi₂₋ₓSi_{y}P_{3-y}O₁₂ (0<x<2, 0≤y<3), LiₓTi_{y}(PO₄)₃ (0<x<2 and 0<y<3), LiₓAl_{y}Ti_{z}(PO₄)₃ (0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (0<a<1, 0<b<1, 0≤x≤1, and 0≤y≤1), or a combination thereof. In one or more embodiments, the crystalline phosphate-based solid electrolyte may be, for example, Li_{1.5}Al_{1.5}Ge_{1.5}(PO₄)₃, Li_{1.3}Al_{0.3}Ge_{1.7}(PO₄)₃, Li_{1.3}Al_{0.3}Ti_{1.7}(PO₄)₃, or a combination thereof.

In an embodiment, the content of the crystalline phosphate-based solid electrolyte included in the composite of the composite cathode may be, in a range of about 0.2 parts by weight to about 20 parts by weight, for example, about 1 part by weight to about 15 parts by weight, about 5 parts by weight to about 10 parts by weight, based on 1 part by weight of the crystalline phosphate-based cathode active material. When the content of the crystalline phosphate-based solid electrolyte is within these ranges, the electronic conduction pathway may be easily formed and the cathode active materials may be connected to each other, and thus the interfacial resistance between the solid electrolyte and the cathode may be reduced.

In the composite according to an embodiment, the crystalline phosphate-based cathode active material may partially or completely surround a surface of the crystalline phosphate-based solid electrolyte. Here, the amorphous interphase may be present between the crystalline phosphate-based solid electrolyte and the crystalline phosphate-based cathode active material.

In an embodiment, a ratio of a peak intensity of an I₍₁₁₋₂₎ peak to a peak intensity of an I₍₁₋₁₂₎ peak (I₍₁₁₋₂₎/I₍₁₋₁₂₎) of the composite and the composite cathode may be less than 1, for example, in a range of about 0.03 to about 0.9, or about 0.05 to about 0.5, and the I₍₁₁₋₂₎ peak appears at a diffraction angle (2θ) of 20.69±0.1°2θ, and the I₍₁₋₁₂₎ peak appears at a diffraction angle (2θ) of 20.9±0.1 °2θ, when analyzed by X-ray diffraction using a CuKα radiation.

In one or more embodiments, the ratio of a peak intensity of an I₍₁₀₃₎ peak to a peak intensity of an I₍₁₀₋₃₎ peak (I₍₁₀₃₎/I₍₁₀₋₃₎) of the composite may be less than 1, for example, in a range of about 0.1 to about 0.9, about 0.3 to about 0.9, or about 0.5 to about 0.9, and the I₍₁₀₃₎ peak appears at a diffraction angle (2θ) of 24.4±0.1°2θ, and the I₍₁₀₋₃₎ peak appears at a diffraction angle (2θ) of 24.7±0.1°2θ, when analyzed by X-ray diffraction using a CuKα radiation.

The composite cathode may include a cathode current collector. In addition, the composite and the composite cathode may include closed pores. In the case of including such closed pores, a more improved ion conduction pathway may be formed compared to the case of including open pores.

The composite cathode may have a highly densified structure with a porosity in a range of about 0.1 percent (%) to about 5 %, for example, about 0.1 % to about 3 %, about 0.1 % to about 1 %, or about 0.1 % to about 0.8 %, based on a total volume of the composite cathode. Also, as described above, the composite cathode does not include a conductive material, and thus may be in an electronic conductor-free state.

The composite cathode according to an embodiment may further include a binder, a filler, a dispersant, or an ionic conduction auxiliary agent.

Non-limiting examples of the binder are styrene butadiene rubber (SBR), polytetrafluoroethylene, polyvinylidene fluoride, or polyethylene. For use as a coating agent, a dispersant, or an ionic conduction auxiliary agent, that are blendable with the composite cathode, suitable materials used in the art for an electrode of a solid secondary battery may be used.

Hereinafter, a method of preparing the composite according to an embodiment and the composite cathode including the composite will be described as follows.

First, a crystalline phosphate-based solid electrolyte, a crystalline phosphate-based cathode active material having electrical conductivity that is about 10 times to about 10⁶ times greater than that of the crystalline phosphate-based solid electrolyte, a binder, and a solvent may be contacted or mixed to provide a composition for forming a composite.

The composition for forming the composite may be subjected to heat treatment under pressure at 700° C. or greater to prepare a cathode active material layer. The pressurization may be performed, for example, at a pressure of 150 megapascals (MPa) or less to prepare a composite.

For the binder and the solvent used in the preparation of the composition for forming the composite, a commercially available ink vehicle (manufactured by Fuelcellmaterials Company) may be used.

When the cathode active material layer is combined with a cathode current collector, a composite cathode may be prepared.

The heat treatment may be performed at a temperature in a range of, for example, about 700° C. to about 800° C., about 700° C. to about 780° C., about 700° C. to about 750° C.

The pressurization may be, for example, roll press, flat press, isotropic press, or pressing using hydrostatic pressure. However, the pressurization methods are not limited thereto, and any pressurization method in the art may be used. The pressurization may be performed at a pressure in a range of about 50 megaPascals (MPa) to about 150 MPa, about 70 MPa to about 150 MPa, or about 100 MPa to about 150 MPa.

When the heat treatment under pressure is performed under the above-described conditions, a composite cathode according to an embodiment may be prepared.

The heat treatment may be performed in an inert gas atmosphere. For the inert gas atmosphere, inert gas such as argon or nitrogen may be used. During the heat treatment, a heating rate may be in a range of about 1° C./minute (°C/min) to about 10° C./min.

In an embodiment, a composition for forming the composite (or a composition for forming the composite cathode) may be provided on a cathode current collector in the preparation of the composite cathode, so as to prepare a composite cathode including the composite.

In one or more embodiments, a composition for forming the composite may be provided on a substrate, so as to prepare a composite cathode. As needed, a process of separating the prepared composite cathode from the substrate may be performed.

In one or more embodiments, the substrate may be a solid electrolyte for a secondary battery.

The composition for forming the composite may further include an additive such as binder, a filler, a dispersant, or an ionic conduction auxiliary agent.

Another aspect of the present disclosure provides a secondary battery including the composite cathode.

The secondary battery may be a lithium secondary battery or an all-solid-state battery.

The all-solid-state battery may be, for example, a multilayer-ceramic (MLC) battery.

The MLC battery may include a cell unit including: a cathode layer including a cathode active material layer; a solid electrolyte layer; and an anode layer including an anode active material layer, wherein the solid electrolyte layer is between the cathode layer and the anode layer, and has a laminate structure comprising a plurality of the cell units disposed such that the cathode active material layer of a first cell faces the anode active material layer of an adjacent cell.

The cathode layer may be the composite cathode according to an embodiment.

In one or more embodiments, the MLC battery may further include a cathode current collector and/or an anode current collector. When the MLC battery includes the cathode current collector, the cathode active material layer may be on both surfaces of the cathode current collector. When the MLC battery includes the anode current collector, the anode active material layer may be on both surfaces of the anode current collector.

The MLC battery may have a laminate comprising a plurality of cell units, each cell unit comprising a cathode active material layer, a solid electrolyte layer, and an anode active material layer, wherein the solid electrolyte layer is between the cathode layer and the anode layer, and disposed such that cathode active material layer of a first cell faces the anode active material layer of an adjacent cell.

In an embodiment, the cell unit may be laminated by providing a current collector layer on one or both of the uppermost layer and the lowermost layer of the laminate, or by arranging a metal layer on the laminate.

The composite cathode according to an embodiment and the secondary battery including the composite cathode may be used as a power supply for applications of Internet of Things (IoT), or a power supply for a wearable device.

The composite cathode according to an embodiment may be applicable to a thin-film battery and an MLC battery. The composite cathode according to an embodiment may be also applicable to small batteries and large batteries for an electric vehicle (EV) and an energy storage system (ESS).

The secondary battery may be an all-solid-state secondary battery including: a cathode layer including a cathode active material layer; an anode layer including an anode current collector and either of a first anode active material layer and a third anode active material layer; and a solid electrolyte layer arranged between the cathode layer and the anode layer, wherein the cathode layer be the composite cathode including the composite according to an embodiment.

The first anode active material layer may include a carbon-based (i.e., carbonaceous) anode active material, a metal anode active material, or a metalloid anode active material.

The carbon-based anode active material may include amorphous carbon crystalline carbon, or a combination thereof, and the metal anode active material or the metalloid anode active material may include gold (Au), platinum (Pt), palladium (Pd), silicon (Si), silver (Ag), aluminum (Al), bismuth (Bi), tin (Sn), zinc (Zn), or a combination thereof.

A second anode active material layer may be further arranged on at least one of a space between the anode current collector and the first anode active material layer, or a space between the solid electrolyte layer and the first anode active material layer, wherein the second anode active material layer may be a metal layer including lithium or lithium alloy.

In the all-solid-state secondary battery according to an embodiment, the third anode active material layer may be a metal layer including lithium or a lithium alloy.

The secondary battery according to an embodiment may be a subminiature all-solid-state secondary battery.

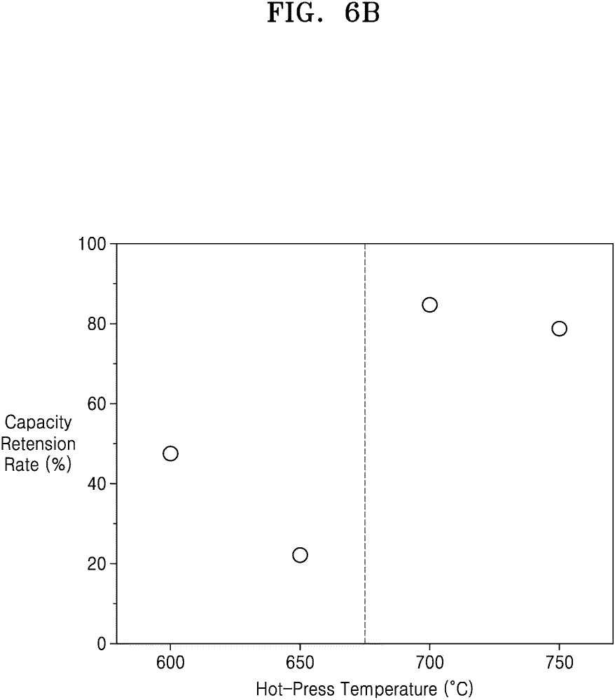

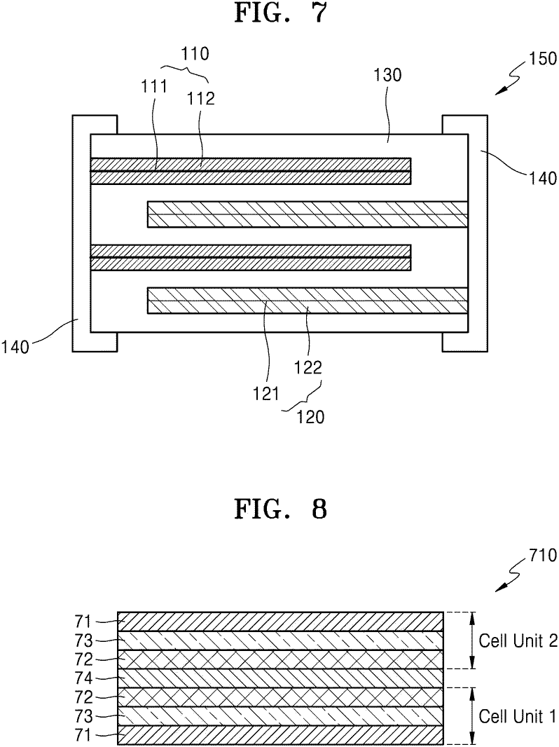

FIG. 7 is an image schematically showing a structure of an MLC battery according to an embodiment.

The MLC battery may be prepared by sequentially stacking an oxide electrode and a solid electrolyte and then simultaneously performing heat treatment thereon.

Referring to FIG. 7, a cathode active material layer 112 may be on a first surface of a cathode current collector 111, so as to form a cathode 110. In an embodiment, cathode active material layers 112 may each be arranged on both surfaces of the cathode current collector 111, so as to form the cathode 110. Here, the cathode 110 may be a composite cathode according to an embodiment.

An anode active material layer 122 may be on a first surface of an anode current collector 121, so as to form an anode 120. In an embodiment, anode active material layers 122 may each be arranged on both surfaces of the anode current collector 121, so as to form an anode 120. Also, as shown in FIG. 7, a solid electrolyte 130 may be arranged between the cathode 110 and the anode 120. An external electrode 140 may be formed at each end of a battery body 150. The external electrode 140 may be connected to the ends of the cathode 110 and the anode 120, wherein the ends of which are exposed to the outside of the battery body 150. In this regard, the external electrode 140 may serve as an external terminal for electrically connecting the cathode 110 and the anode 120. One of the pair of the external electrode 140 may be connected to the cathode 110 of which the end is exposed to the outside of the battery body 150, and the other may be connected to the anode of which the end is exposed to the outside of the battery body 150.

The secondary battery according to an embodiment may be a laminate solid battery including at least a first end cell and a second end cell, each comprising a cathode layer, a solid electrolyte layer, and an anode layer staked in the stated order, and an internal current collector in contact with the cathode layer of each of the first end cell and the second end cell or between the anode layer of each of the first end cell and the second end cell, so as to be interposed between the first end cell and the second end cell.

The anode active material of the anode active material layer may be an oxide including an element of Group 2 to Group 14 of the periodic table, and for example, may be lithium titanium oxide, lithium transition metal oxide, lithium metal phosphate, titanium oxide, vanadium oxide, or a combination thereof. “Group” means a group of the Periodic Table of the Elements according to the International Union of Pure and Applied Chemistry (“IUPAC”) Group 1-18 group classification system.

Lithium metal phosphate may be Li₃Fe₂(PO₄)₃ or LiₓV₂(PO₄)₃ (0<x≤5).

The oxide anode may include a lithium compound of, for example, Li_{4/3}Ti_{5/3}O₄, LiTiO₂, LiM1ₛM2ₜOᵤ (wherein M1 and M2 may each be a transition metal, and s, t, and u may each be a positive number), LiₓV₂(PO₄)₃ (0<x≤5), Li₃Fe₂(PO₄)₃, or non-lithium compound of TiOₓ (0<x≤3), V₂O₅, or a combination thereof. For example, the lithium compound may be Li_{4/3}Ti_{5/3}O₄, or LiTiO₂. TiOₓ (0<x≤3) may be, for example, TiO₂.

The anode active material may include, for example, vanadium oxide (V₂O₅), Li₄Ti₅O₁₂, TiO₂, LiTiO₂, Li₃V₂(PO₄)₃, Li3Fe₂(PO₄)₃, or a combination thereof.

When the current collector layer serves as a positive electrode current collector and a negative electrode current collector, the current collector layer may comprise any metal among Ni, Cu, Ag, Pd, Au, Pt, or a combination thereof, or may comprise an alloy including any metal among Ni, Cu, Ag, Pd, Au, Pt, or a combination thereof. In the case of an alloy, an alloy includes two or more metals of Ni, Cu, Ag, Pd, Au, or Pt, and an example thereof is an Ag/Pd alloy. In addition, the metal and the alloy may be a single type or a mixture of two or more types. A material for forming the current collector layer serving as a positive electrode current collector and a material for forming the current collector layer serving as a negative electrode current collector may be identical to or different from each other. In particular, in an alloy including silver (Ag) and palladium (Pd) or a mixed powder thereof, a melting point may be continuously and arbitrarily changed from a melting point of Ag (962° C.) to a melting point of Pd (1,550° C.) depending on a mixing ratio, so that a melting point may be adjusted depending on a co-firing temperature. In addition, such an alloy and a mixed powder thereof may have high electron conductivity so that there is an advantage that an internal resistance of a battery may be controlled to a minimum value.

For the metal layer, the same material as the above-described material for the current collector layer may be used. The material for forming the metal layer and the material for forming the current collector may be identical to or different from each other.

The solid electrolyte may include an ion conductive inorganic material, and for example, an oxide-based solid electrolyte may be used.

The oxide-based solid electrolyte may include, for example, Li_{1+x+y}AlₓTi₂₋ₓSi_{y}P₃₋_{y}O₁₂ (0<x<2 and 0≤y<3), BaTiO₃, Pb(Zr₁₋ₚTiₚ)O₃ (0≤p≤1, PZT), Pb₁₋ₓLaₓZr_{1-y}Ti_{y}O₃(PLZT) (0≤x<1 and 0≤y<1), Pb(Mg_{⅓}Nb_{⅔})O₃—PbTiO₃ (PMN—PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, lithium phosphate (Li₃PO₄), lithium titanium phosphate (LiₓTi_{y}(PO₄)₃, 0<x<2, and 0<y<3), lithium aluminum titanium phosphate (LiₓAl_{y}Ti_{z}(PO₄)₃, 0<x<2, 0<y<1, and 0<z<3), Li_{1+x+y}(Al₁₋ₚGaₚ)ₓ(Ti₁₋_{q}Ge_{q})₂₋ₓSi_{y}P_{3-y}O₁₂ (0≤x≤1, 0≤y≤1, 0≤p≤1, and 0≤q≤1), lithium lanthanum titanate (LiₓLa_{y}TiO₃, 0<x<2, and 0<y<3), lithium germanium thiophosphate (LiₓGe_{y}P_{z}S_{w}, 0<x<4, 0<y<1, 0<z<1, and 0<w<5), lithium nitride-based glass (LiₓN_{y}, 0<x<4, and 0<y<2), SiS₂ (LiₓSi_{y}S_{z}, 0<x<3, 0<y<2, and 0<z<4), P₂S₅-based glass (LiₓP_{y}S_{z}, 0<x<3, 0<y<3, and 0<z<7), Li₂O, LiF, LiOH, Li₂CO₃, LiAlO₂, Li₂O—Al₂O₃—SiO₂—P₂O₅—TiO₂—GeO₂—based ceramics, garnet-based ceramics (Li₃₊ₓLa₃M₂O₁₂, M is Te, Nb, or Zr, and x is an integer from 1 to 10), or a combination thereof.

The solid electrolyte may be a lithium compound of, for example, Li_{3.25}Al_{0.25}SiO₄, Li₃PO₄, LiPₓSi_{y}O_{z} (wherein x, y, and z are each any positive number), or a combination thereof. For example, the solid electrolyte may be Li_{3.5}P_{0.5}Si_{0.5}O₄.

FIGS. 7 and 8 each schematically show a cross-sectional structure of a laminate-type solid battery according to an embodiment.

As shown in FIG. 8, a laminate-type solid battery 710 includes a first end cell unit 1 and a second end cell unit 2 that are laminated with an inner current collector layer 74. Each of the first end cell unit and the second end cell unit may comprise a cathode layer 71, a solid electrolyte layer 73, and an anode layer 72 that are laminated in the stated order. The cathode layer 71 may be, for example, the composite cathode according to an embodiment.

The inner current collector layer 74 may be laminated along with cell unit 1 and cell unit 2 in a way that the anode layer 72 of cell unit 2 is arranged to be adjacent to a first surface of the inner current collector layer 74 (see the upper portion of FIG. 8) and the anode layer 72 of cell unit 1 is arranged to be adjacent to the second surface of the inner current collector layer 74 (see the lower portion of FIG. 8). In FIG. 8, the inner current collector layer 74 is arranged to be in contact with the anode layer 72 of each of cell unit 1 and cell unit 2. However, the inner current collector layer 74 may be arranged to be in contact with the cathode layer 71 of each of cell unit 1 and cell unit 2. The inner current collector layer 74 may include an electron conductive material. The inner current collector layer 74 may further include an ion conductive material. When the ion conductive material is further included, excellent voltage stabilization characteristics may be resulted.

In the laminate-type solid battery 710 having the above-described structure according to an embodiment, the same poles may be arranged on both surfaces of the inner current collector layer 74, and thus a laminated monopolar solid battery 710 may be obtained. Accordingly, a high-capacity laminated solid battery 710 may be obtained.

Also, since the inner current collector layer 74 between cell unit 1 and cell unit 2 of the laminated-type solid battery 710 includes an electron conductive material, two adjacent cell units may be electrically connected in a row, and at the same time, the cathode layers 71 or the anode layers 72 of the two adjacent cell units may be ion conductively connected to each other. Accordingly, the potentials of the adjacent cathode layers 71 or the adjacent anode layers 72 may be averaged through the inner current collector layer 74, thereby obtaining a stable output voltage.

In addition, the cell units of the laminated solid battery 10 may be electrically connected in a row by eliminating an external current collector such as a lead-out tab. In this regard, the laminated-type solid battery 710 having excellent space utilization and excellent cost performance may be obtained.

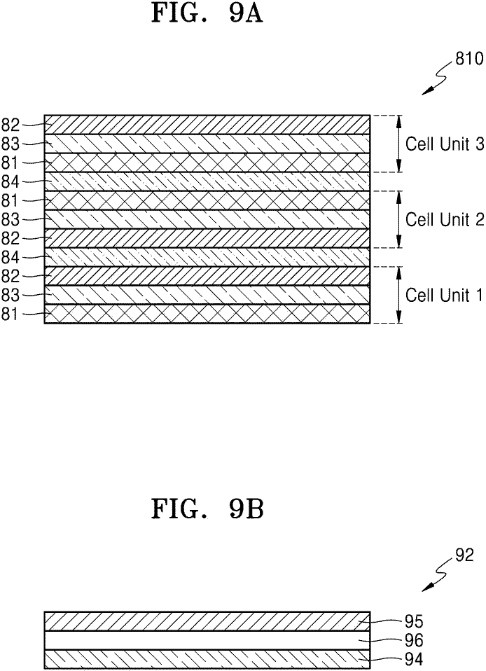

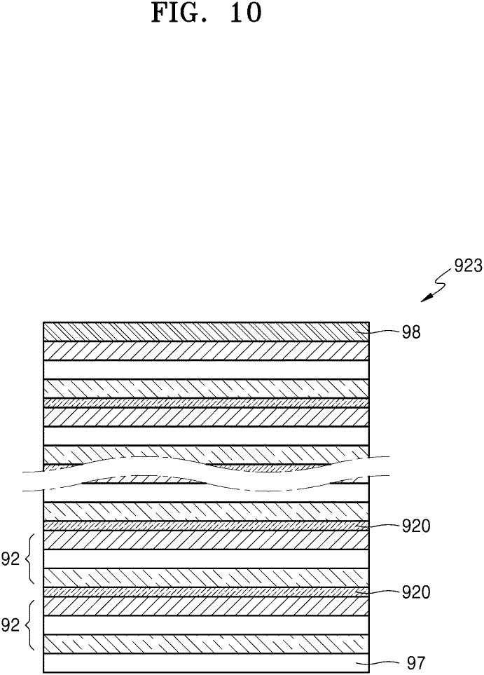

Referring to FIG. 9A, a stack may include a cathode layer 81, an anode layer 82, a solid electrolyte layer 83, and an inner current collector layer 84. Such a stack may be laminated and then subjected to thermocompression bonding, so as to obtain a laminated solid battery stack 810. Here, the cathode layer 81 is in a form of a sheet for the cathode layer 81, and the anode layer 82 is in a form of two sheets for the anode layer 82. The cathode layer 82 may include the composite cathode according to an embodiment.

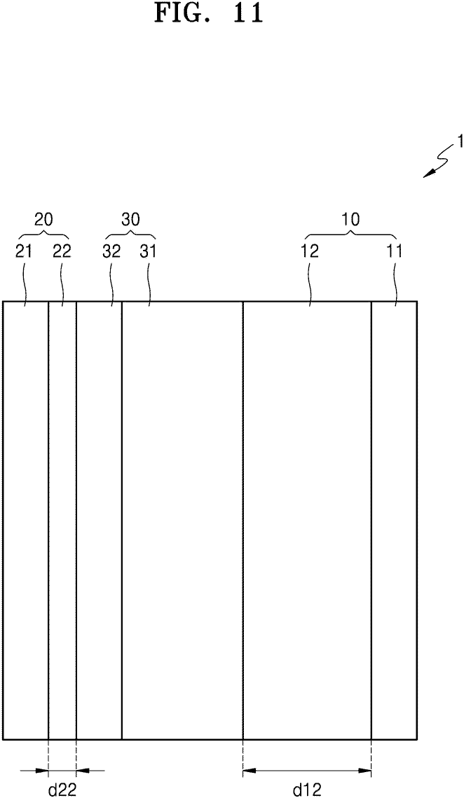

FIGS. 9B and 10 show a stack of another embodiment of an all-solid-state secondary battery according to an embodiment. In FIGS. 9B and 10, a cathode active material layer may include the composite cathode according to an embodiment.

FIG. 9B shows a structure of the most basic cell unit 92 of the all-solid-state secondary battery. The cell unit 92 has a structure in which a cathode active material layer 94, an ion conductive inorganic material layer 96, and an anode active material layer 95 are successively laminated in order.

FIG. 10 shows a structure of a stack of the all-solid-state secondary battery.

In the all-solid-state secondary battery, a cathode extracting electrode may be arranged to be in contact with the cathode active material layer at the lower end of the stack, and an anode extracting electrode may be arranged to be in contact with the anode active material layer at the top end of the stack. In the present specification, the terms “top end” and “lower end” refer to relative positional relationship.

The laminate 923 may have a structure including a plurality of cell units 92 and current collector layers on the uppermost layer and the lowermost layer of the laminate 923, wherein the cell units are laminated so that a cathode active material layer 94 and an anode active material layer 95 in each cell unit 92 face each other. One of the current collector layers constituting the upper most layer and the lowermost layer may be connected to a cathode active material layer and serve as a cathode current collector, and the other current collector layer may be connected to an anode active material layer and serve as an anode current collector. That is, the current collector layer 97 of the lowermost layer may be connected to the cathode active material layer 94 and serve as a cathode current collector, and the current collector layer 98 of the uppermost layer may be connected to the anode active material layer 95 and serve as an anode current collector.

Here, the current collector layer may serve as an extracting electrode. In FIG. 10, the current collector layer 97 of the lowermost layer may serve as a cathode extracting electrode, and the current collector layer 98 of the uppermost layer may serve as an anode extracting electrode. Alternatively, a separate extracting electrode may be provided on the current collector layer. For example, a cathode extracting electrode in contact with the current collector layer 97 may be provided at the bottom end and an anode extracting electrode in contact with the current collector layer 98 may be provided at the top end of the laminate 923.

As shown in FIG. 10, the laminate 923 may have a laminated structure including cell units 92 laminated via a metal layer 920. In the presence of the metal layer 920 between the cell units 92, ions move only within the individual cell unit so that the all-solid-state secondary battery may be expected to function more reliably as a series-type all-solid-state secondary battery. The laminate 923 of FIG. 10 includes the current collector layers, but as described above, the current collector layers are optionally provided.

Regarding the laminate of the all-solid-state secondary battery, when the number of the cell unit 92 is two or more, a so-called series-type all-solid-state secondary battery may be formed. The number of the cell units may vary within a wide range based on capacity or current value of the desired all-solid-state secondary battery.

A secondary battery according to an embodiment may be an all-solid-state secondary battery. Hereinafter, an all-solid-state secondary battery according to an embodiment will be described in more detail with reference to the accompanying drawings.

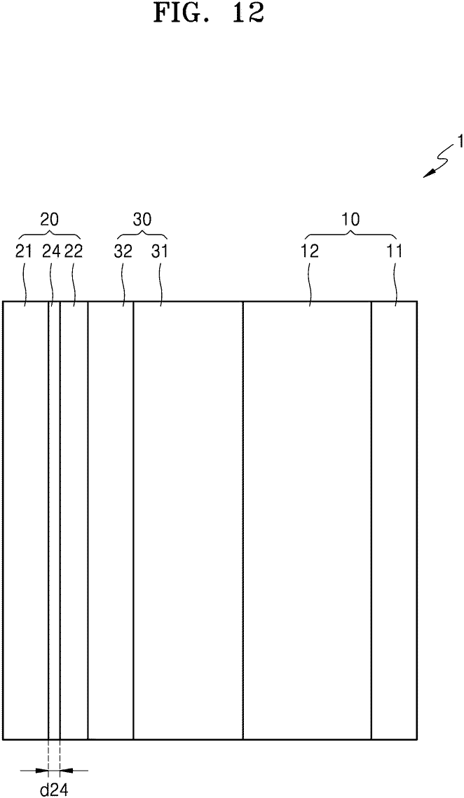

Referring to FIGS. 11 to 13, an all-solid-state secondary battery 1 includes: an anode layer 20 including an anode current collector layer 21 and a first anode active material layer 22; a cathode layer 10 including a cathode current collector layer 11 and a cathode active material layer 12; and a solid electrolyte layer 30 arranged between the anode layer 20 and the cathode layer 10. The cathode layer 10 may include a solid electrolyte. The cathode active material layers of FIGS. 11 to 13 may each be the composite cathode according to an embodiment.

### Anode Layer

Referring to FIGS. 11 to 13, an anode layer 20 may include an anode current collector layer 21 and a first anode active material layer 22, and the first anode active material layer 22 may include an anode active material. The anode current collector layer 21 may be omitted.

The anode active material layer included in the first anode active material layer 22 may be, for example, in a particle form. In an embodiment, the anode active material in a particle form may have an average particle diameter of, for example, about 4 micrometers (µm) or less, about 3 µm or less, about 2 µm or less, about 1 µm or less, or about 900 nanometers (nm) or less. In one or more embodiments, the anode active material in a particle form may have an average particle diameter in a range of, for example, about 10 nm to about 4 µm, about 10 nm to about 2 µm, about 10 nm to about 1 µm, or about 10 nm to about 900 nm. When the anode active material has an average particle diameter within these ranges, reversible absorption and/or desorption of lithium during a charge/discharge process may be more easily done. The average particle diameter of the anode active material may be, for example, a median diameter (D50) measured by using a laser particle size distribution meter.

The anode active material included in the first anode active material layer 22 may include, for example, at least one of a carbon-based anode active material, a metal anode active material, a metalloid anode active material, or a combination thereof.

The carbon-based anode active material may be particularly amorphous carbon. Examples of the amorphous carbon are carbon black (CB), acetylene black (AB), furnace black (FB), ketjen black (KB), or graphene, but are not limited thereto. Any agent classified as amorphous carbon in the art may be used. The amorphous carbon is carbon that does not have crystallinity or has very low crystallinity, and in this regard, the amorphous carbon is distinguished from crystalline carbon or graphite-based carbon.

The metal anode active material or the metalloid anode active material may include gold (Au), platinum (Pt), palladium (Pd), silicon (Si), silver (Ag), aluminum (Al), bismuth (Bi), tin (Sn), zinc (Zn), or a combination thereof, but is not necessarily limited thereto. Any material used in the art as a metal negative active material or a metalloid negative active material to form an alloy with lithium or a compound with lithium may be used. For example, since nickel (Ni) does not form an alloy with lithium, it is not used as a metal anode active material.

The first anode active material layer 22 may include, among the examples above, one kind of the anode active material or a mixture of a plurality of different anode active materials. In an embodiment, the first anode active material layer 22 may include amorphous carbon only, or Au, Pt, Pd, Si, Ag, Al, Bi, Sn, Zn, or a combination thereof. In one or more embodiments, the first anode active material layer 22 may include a mixture of amorphous carbon and Au, Pt, Pd, Si, Ag, Al, Bi, Sn, Zn, or a combination thereof. In the case of the mixture of amorphous carbon and Au, a mixture ratio (i.e., a weight ratio) may be, for example, in a range of about 10:1 to about 1:2, about 5:1 to about 1:1, or about 4:1 to about 2:1, but is not necessarily limited thereto. Such a ratio may be selected according to the desired characteristics of the all-solid-state secondary battery 1 . When the anode active material has the composition described above, the all-solid-state secondary battery 1 may have further improved cycle characteristics.

The anode active material included in the first anode active material layer 22 may be, for example, a mixture of a first particle comprising amorphous carbon and a second particle comprising a metal or a metalloid. The metal or the metalloid may include, for example, Au, Pt, Pd, Si, Ag, Al, Bi, Sn, Zn, or a combination thereof. Alternatively, the metalloid may be a semiconductor. In such a mixture, an amount of the second particle may be, in a range of about 8 weight percent (wt%) to about 60 wt%, about 10 wt% to about 50 wt%, about 15 wt% to about 40 wt%, or about 20 wt% to about 30 wt%, based on a total weight of the mixture. When the amount of the second particle is within these ranges, the all-solid-state secondary battery 1 may have further improved cycle characteristics.

The first anode active material layer 22 may include, for example, a binder. Examples of the binder are styrene-butadiene rubber (SBR), polytetrafluoroethylene (PTFE), polyvinylidene fluoride (PVDF), polyethylene, vinylidene fluoride/hexafluoro propylene copolymer, polyacrylonitrile, polymethylmethacrylate, but are not limited thereto. Any material used as a binder in the art may be used. The binder may be used alone or in combination with other binders.

When the first anode active material layer 22 includes the binder, the first anode active material layer 22 may be stabilized on the anode current collector 21. In addition, cracking of the first anode active material layer 22 may be suppressed despite of a change in volume and/or a relative position of the first anode active material layer 22 during a charge/discharge process. For example, when the first anode active material layer 22 does not include a binder, the first anode active material layer 22 may be easily separated from the anode current collector 21. Then, the anode current collector 21 may be exposed by a portion where the first anode active material layer 22 is separated from the anode current collector 21. Thus, when in contact with the solid electrolyte layer 30, the occurrence of a short circuit may increase. The first anode active material layer 22 may be prepared by, for example, coating the anode current collector 21 with a slurry in which a material of the first anode active material layer 22 is dispersed, and drying the anode current collector 21. When the first anode active material layer 22 includes the binder, the anode active material may be stably dispersed in the slurry. For example, when the slurry is coated on the anode current collector 21 by a screen printing method, clogging of a screen (for example, clogging by agglomerate of the anode active material) may be suppressed.

A thickness (d22) of the first anode active material layer may be, for example, about 50 percent (%) or less, about 30 % or less, about 10 % or less, or about 5 % or less of a thickness (d12) of the cathode active material layer. The thickness d22 of the first anode active material layer may be, for example, in a range of about 1 µm to about 20 µm, about 2 µm to about 10 µm, or about 3 µm to about 7 µm. When the thickness d22 of the first anode active material layer is within these ranges, the all-solid-state secondary battery 1 may have excellent cycle characteristics.

A charging capacity of the first anode active material layer 22 may be, for example, about 50 % or less, about 40 % or less, about 30 % or less, about 20 % or less, about 10 % or less, about 5 % or less, or about 2 % or less, based on a total charging capacity of the cathode active material layer 12. The charging capacity of the first anode active material layer 22 may be, for example, in a range of about 0.1 % to about 50 %, about 0.1 % to about 40 %, about 0.1 % to about 30 %, about 0.1 % to about 20 %, about 0.1 % to about 10 %, about 0.1 % to about 5 %, or about 0.1 % to about 2 %, based on a total charging capacity of the cathode active material layer 12. When the charging capacity of the first anode active material layer 22 is within these ranges, the all-solid-state secondary battery 1 may have excellent cycle characteristics. The charging capacity of the cathode active material layer 12 may be obtained by multiplying the charging specific capacity (mAh/g) by the mass of the cathode active material in the cathode active material layer. The anode current collector 21 may comprise, for example, a material that is not reactive with lithium, that is, a material that does not form both an alloy and a compound. Examples of the material of the anode current collector 21 are copper Cu, stainless steel, titanium Ti, iron Fe, cobalt Co, nickel Ni, or a combination thereof, but not necessarily limited thereto. Any material used as the current collector in the art may be used. The anode current collector 21 may comprise one type of the metal described above, or an alloy of two or more types of metal or a coating material. The anode current collector 21 may be, for example, in a plate or foil form.

The first anode active material layer 22 may further include an additive used in the all-solid-state secondary battery 1 of the art, and examples of the additive are a filler, a dispersant, an ion conductive agent, or a combination thereof.

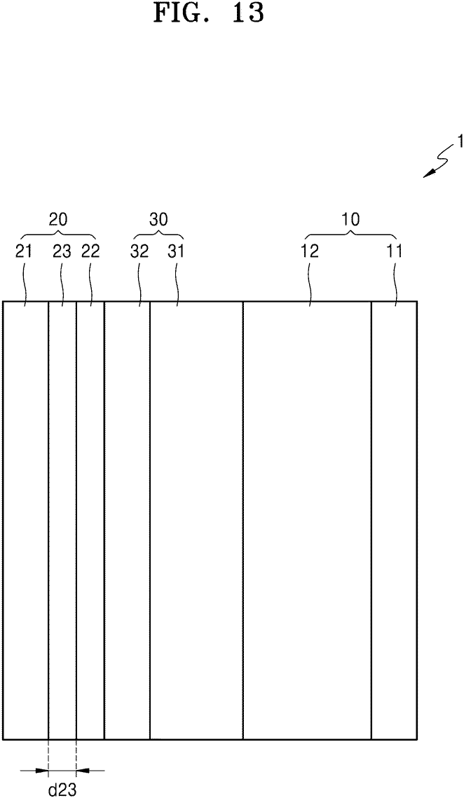

Referring to FIG. 12, the all-solid-state secondary battery 1 may further include, for example, a thin-film (i.e., film) layer 24 including an element capable of forming an alloy with lithium on the anode current collector 21. The thin-film layer 24 may be arranged between the anode current collector 21 and the first anode active material layer 22. The thin-film layer 24 may include, for example, an element capable of forming an alloy with lithium. Examples of the element capable of forming an alloy with lithium are Au, Ag, Zn, Sn, In, Si, Al, Bi, or a combination thereof, but are not necessarily limited thereto. Any element capable of forming an alloy with lithium in the art may be used. The thin-film layer 24 may comprise one of these metals, or an alloy of several types of these metals. When the thin-film layer 24 is arranged on the anode current collector 21, an extraction form of a second anode active material layer (not shown) extracted from between the thin-film layer 24 and the first anode active material layer 22 may be further planarized, thereby more improving the cycle characteristics of the all-solid-state secondary battery 1.

A thickness d24 of the thin-film layer may be, for example, in a range of about 1 nm to about 800 nm, about 10 nm to about 700 nm, about 50 nm to about 600 nm, or about 100 nm to about 500 nm. When the thickness d24 of the thin-film layer is within these ranges, the all-solid-state battery 1 may have high energy density and excellent cycle characteristics. The thin-film layer 24 may be deposited on the anode current collector 21 by, for example, a vacuum deposition method, a sputtering method, or a plating method. However, the deposition methods are not limited thereto, and any method of forming a thin-film layer in the art may be used.

Referring to FIG. 13, the all-solid-state secondary battery 1 may further include, for example, a second anode active material layer 23 between the anode current collector 21 and the solid electrolyte layer 30 by a charging process. Alternatively, the all-solid-state secondary battery 1 may further include, for example, a second anode active material layer 23 between the anode current collector 21 and the first anode active material layer 22 by a charging process. Alternatively, although not shown in the figure, the all-solid-state secondary battery 1 may further include, for example, a second anode active material layer 23 between the solid electrolyte layer 30 and the first anode active material layer 22 by a charging process. Alternatively, although not shown in the figure, the all-solid-state secondary battery 1 may further include, for example, a second anode active material layer 23 arranged within the first anode active material layer 22 by a charging process.

The second anode active material 23 may be a metal layer including lithium or a lithium alloy. The metal layer may include lithium or a lithium alloy. In this regard, the second anode active material layer 23 is a metal layer including lithium so that it serves as a lithium reservoir. Examples of the lithium alloy are Li—Al alloy, Li—Sn alloy, Li—In alloy, Li—Ag alloy, Li—Au alloy, Li—Zn alloy, Li—Ge alloy, Li—Si alloy, or a combination thereof. However, the lithium alloy is not limited thereto, and any material used as lithium alloy in the art may be used. The second anode active material layer 23 may consist of one kind of these alloys, lithium only, or several kinds of alloys.

A thickness d23 of the second anode active material layer is not particularly limited, but for example, may be in a range of about 1 um to about 1,000 um, about 1 um to about 500 um, about 1 um to about 200 um, about 1 um to about 150 um, about 1 um to about 100 um, or about 1 um to about 50 um. When the thickness d23 of the second anode active material layer is within these ranges, the all-solid-state secondary battery 1 may have excellent cycle characteristics. The second anode active material layer 23 may be, for example, a metal foil having a thickness within these ranges.

In the all-solid-state secondary battery 1, the second anode active material layer 23 may be, for example, arranged between the anode current collector 21 and the first anode active material layer 22 before assembling the all-solid-state secondary battery 1, or may be extracted from between the anode current collector 21 and the first anode active material layer 22 by a charging process after assembling all-solid-state secondary battery 1.

When the second anode active material layer 23 is arranged between the anode current collector 21 and the first anode active material layer 22 before assembling the all-solid-state secondary battery 1, the second anode active material layer 23 which is a metal layer including lithium may serve as a lithium reservoir. Accordingly, the all-solid-state secondary battery 1 including the second anode active material layer 23 may have further improved cycle characteristics. For example, before assembling the all-solid-state secondary battery 1, a lithium foil may be arranged between the anode current collector 21 and the first anode active material layer 22.

When the second anode active material layer 23 is arranged by a charging process after assembling the all-solid-state secondary battery 1, the second anode active material layer 23 is not included yet during assembling the all-solid-state secondary battery 1 so that the energy density of the all-solid-state secondary battery 1 may increase. For example, in a charging process, the all-solid-state secondary battery 1 may be charged beyond the charging capacity of the first anode active material layer 22. That is, the first anode active material layer 22 may be overcharged. At the beginning of the charging process, lithium may be absorbed in the first anode active material layer 22. That is, the anode active material included in the first anode active material layer 22 may form an alloy or compound with lithium ions that are moved from the cathode layer 10. When charged beyond the capacity of the first anode active material layer 22, for example, lithium may be extracted from the rear surface of the first anode active material layer 22, i.e., from a space between the anode current collector 21 and the first anode active material layer 22. Then, due to extracted lithium, a metal layer corresponding to the second anode active material layer 23 may be formed. The second anode active material layer 23 may be a metal layer mainly comprising lithium (i.e., lithium metal). Such a result may be obtained, for example, when the anode active material included in the first anode active material layer 22 comprises a material capable of forming an alloy or compound with lithium. In a discharging process, lithium of the metal layer, i.e., the first anode active material layer 22 and the second anode active material layer 23, may be ionized and moved toward the cathode layer 10. Therefore, lithium may be used as the anode active material in the all-solid-state secondary battery 1. In addition, since the first anode active material layer 22 coats the second anode active material layer 23, the first anode active material layer 22 may serve as a protective layer of the second anode active material layer 23, i.e., the metal layer, and may simultaneously have a role in suppressing extraction growth of lithium dendrite. Accordingly, a short circuit and capacity reduction of the all-solid-state secondary battery 1 may be suppressed, and as a result, the all-solid-state secondary battery 1 may have improved cycle characteristics. In addition, when the second anode active material layer 23 is arranged by a charging process after assembling the all-solid-state secondary battery 1, the anode current collector 21, the first anode active material layer 22, and a region therebetween may be, for example, a lithium-free layer or a region not including lithium metal or lithium alloy in the beginning state or the post-discharge state of the all-solid-state secondary battery.

Referring to FIG. 13, the all-solid-state secondary battery 1 has a structure in which the second anode active material layer 23 is arranged on the cathode current collector 21, and the solid electrolyte layer 30 is arranged on the second anode active material layer 23. The second anode active material 23 may be, for example, a lithium metal layer or a lithium alloy layer.

### Solid Electrolyte Layer

Referring to FIGS. 11 to 13, the solid electrolyte layer 30 may include an oxide-based solid electrolyte.

The oxide-based solid electrolyte may be, for example, Li₁+ₓ+_{y}AlₓTi₂₋ₓSi_{y}P_{3-y}O₁₂ (0<x<2, 0≤y<3), BaTiO₃, Pb(Zr_{1-pT}iₚ)O₃ (0≤p≤1, PZT), Pb₁₋ₓLaₓZr_{1-y}Ti_{y}O₃ (PLZT) (0≤x<1 and 0≤y<1), Pb(Mg_{⅓}Nb_{⅔})O₃—PbTiO₃ (PMN—PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2 and 0<y<3), LiₓAl_{y}Ti_{z}(PO₄)₃ (0<x<2, 0<y<1, and 0<z<3), Li₁+ₓ+_{y}(Al₁₋ₚGaₚ)ₓ(Ti_{1-q}Ge_{q})₂₋ₓSi_{y}P₃₋_{y}O₁₂ (0≤x≤1, 0≤y≤1, 0≤p≤1, and 0≤q≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, Li₃+ₓLa₃M₂O₁₂ (wherein M is Te, Nb, or Zr, and x is an integer from 1 to 10), or a combination thereof.

The oxide-based solid electrolyte may be, for example, a garnet-type solid electrolyte Li₇La₃Zr₂O₁₂ (LLZO), Li₃+ₓLa₃Zr₂₋ₐMₐO₁₂ (M doped LLZO, wherein M is Ga, W, Nb, Ta, or Al, and x is an integer from 1 to 10, and 0.05≤a≤0.7), or a combination thereof.

In an embodiment, the solid electrolyte layer 30 may include LLZO solid electrolyte.

The solid electrolyte layer 30 may include, for example, Li₇La₃Zr₂O₁₂ (LLZO), Li₆.₄La₃Zr₁.₇ W₀.₃O₁₂, Li₆.₅La₃Zr₁.₅Ta₀.₃O₁₂, Li₇La₃Zr₁.₇ W₀.₃O₁₂, Li₄.₉La₂.₅Ca₀.₅Zr₁.₇Nb₀.₃O₁₂, Li₄.₉Ga₂.₁ La₃Zr₁.₇ W₀.₃O₁₂, Li₆.₄La₃Zr₁.₇ W₀.₃O₁₂, Li₇La₃Zr_{1.5} W_{0.5}O₁₂, Li₇La₂.₇₅Ca₀.₂₅Zr₁.₇₅Nb₀.₂₅O₁₂, Li₇La₃Zr_{1.5}Nb₀.₅O₁₂, Li₇La₃Zr_{1.5}Ta₀.₅O₁₂, Li₆.₂₇₂La₃Zr₁.₇ W₀.₃O₁₂, Li₅.₃₉Ga₁.₆iLa₃Zr₁.₇ W₀.₃O₁₂, Li₆.₅La₃Zr₁.₅Ta₀.₃O₁₂, or a combination thereof.

### Cathode Layer

The cathode layer 10 may include the cathode current collector 11 and the cathode active material layer 12. The cathode layer 10 may include the composite cathode including the composite according to an embodiment.

The cathode current collector 11 may be, for example, a plate or a foil, each comprising In, Cu, Mg, stainless steel, Ti, Fe, Co, Ni, Zn, Al, Ge, Li, or an alloy thereof. The cathode current collector 11 may be omitted.

The cathode layer 10 may include the composite cathode according to an embodiment.

Regarding a method of preparing the all-solid-state secondary battery 1, the solid electrolyte layer 30 may be arranged on the cathode layer 10, and the anode layer 20 may be arranged on the solid electrolyte layer 30.

In an embodiment, the solid electrolyte layer 30 may be prepared by coating a composition for forming the solid electrolyte layer on a separate substrate, drying the coated substrate, and then, separating the solid electrolyte layer from the substrate, or may be prepared in a form of a sheet including the substrate. Non-limiting examples of the substrate are a polyethylene terephthalate film, or a polyethylene nonwoven fabric.

In one or more embodiments, the solid electrolyte layer 30 may be prepared by coating a composition for forming the first solid electrolyte layer on the cathode layer 10 and drying the coated cathode layer 10, or may be prepared by transcription, e.g., forming the first solid electrolyte layer on a release layer and then transferring the first solid electrolyte layer onto the cathode layer 10.

Subsequently, the cathode layer, the solid electrolyte layer, and the anode layer may be packaged with a packaging material, and then pressurized, so as to prepare an all-solid-state battery. Here, the pressurization may be performed by roll press, hot press, or warm isostatic press.

When roll press or hot press is used for the pressurization, mass production may be possible, and a tight interface may be formed in the process of compression of the electrode layers and the solid electrolyte layer.

### Preparation of Anode Layer

An anode active material of the first anode active material layer 22, a conductive material, a binder, or a solid electrolyte, may be added to a polar solvent or a non-polar solvent, so as to prepare a slurry. The slurry thus prepared may be coated on the anode current collector 21, and dried to prepare a first laminate. Subsequently, the first laminate may be pressurized to prepare the anode layer 20. The pressurization may be performed by, for example, roll press, or flat press. However, examples of the pressurization are not limited thereto, and any press used in the art may be used. The pressurization may be omitted.

The anode layer may include an anode current collector and a first anode active material which is arranged on the anode current collector and includes an anode active material, wherein the anode active material may include a carbon-based anode active material, or a metal or metalloid anode active material, and the carbon-based anode active material may include an amorphous carbon, or a crystalline carbon. Also, the metal or metalloid anode active material may include Au, Pt, Pd, Si, Ag, Al, Bi, Sn, Zn, or a combination thereof.

A second anode active material layer may be further arranged between the anode current collector and the first anode active material layer and/or between solid electrolyte layer and the first anode active material layer, wherein the second anode active material layer may be a metal layer including lithium or lithium alloy.

### Preparation of Solid Electrolyte Layer

The solid electrolyte layer 30 may be, for example, prepared by using a solid electrolyte comprising an oxide-based solid electrolyte material.

### Preparation of All-Solid-State Secondary Battery

The cathode layer 10, the anode layer 20, and the solid electrolyte layer 30 that are prepared as described above may be laminated in such a way that the cathode layer 10 and the anode layer 20 include the solid electrolyte layer 30 therebetween, thereby preparing the all-solid-state secondary battery 1. The cathode layer 10 may be the composite cathode according to an embodiment.

For example, the solid electrolyte layer 30 may be arranged on the cathode layer 10 to prepare a second laminate. Subsequently, the anode layer 20 may be arrange on the second laminate so that the solid electrolyte layer 30 may be in contact with the first anode active material layer, thereby preparing the all-solid-state secondary battery 10.

The configuration and preparation method of the above-described all-solid-state secondary battery are exemplary embodiments, and configuration and preparation procedures may be appropriately changed.

The all-solid-state secondary battery according to an embodiment may be mounted on a small ITS (Intelligent Transport Systems) or a large electric vehicle, depending on the capacity and size of the battery.

Hereinafter, the present disclosure will be described in detail with reference to Examples and Comparative Examples, but is not limited thereto.

### EXAMPLES

### Preparation of Crystalline Pphosphate-Based Bathode Active Material

### Preparation Example 1

Li₂CO₃, V₂O₅, and (NH₄)₂HP0₄ were mixed to obtain a precursor mixture, and ethanol was added thereto. Then, a milling process was performed thereon for 10 hours in a ball mill. Here, the amounts of Li₂CO₃, V₂O₅, and (NH₄)₂HPO₄ were stoichiometrically controlled to obtain a cathode active material having a composition shown in Table 1, and the amount of ethanol was about 100 parts by weight, based on 100 parts by weight of the total amounts of Li₂CO₃, V₂O₅, and (NH₄)₂HPO₄.

The milled product was dried at 90° C. for 12 hours, and the dried product was heat-treated in the air at 750° C. for 12 hours, thereby obtaining a crystalline phosphate-based cathode active material (Li₃V2(PO₄)3).

### Preparation Example 2

A crystalline phosphate-based cathode active material having a composition shown in Table 1 was obtained in the same manner as in Preparation Example 1, except that, in the preparation of a precursor mixture, Fe₂O₃ was used instead of V₂O₅, and the amounts of Li₂CO₃, Fe₂O₃, and (NH₄)₂HPO₄ in the precursor mixture were stoichiometrically adjusted to obtain the crystalline phosphate cathode active material of Table 1.

### Preparation Example 3

A crystalline phosphate-based cathode active material having a composition shown in Table 1 was obtained in the same manner as in Preparation Example 1, except that, in the preparation of a precursor mixture, CoO was used instead of V₂O₅, and the amounts of Li₂CO₃, CoO, and (NH₄)₂HPO₄ in the precursor mixture were stoichiometrically adjusted to obtain a target product having the composition of Table 1.

TABLE 1

| Division | Composition | Heat treatment temperature (°C) |
|---|---|---|
| Preparation Example 1 | Li₃V₂(PO₄)₃ | 750 |
| Preparation Example 2 | LiFePO₄ | 750 |
| Preparation Example 3 | LiCoPO₄ | 750 |

Preparation of composite, composite cathode including the composite, and lithium secondary battery including the composite cathode

### Example 1

First, a composite cathode was prepared according to the following procedure.

The crystalline phosphate-based cathode active material (Li₃V₂(PO₄)₃, LVP) of Preparation Example 1, a crystalline solid electrolyte (Li_{1.5}Al_{0.5}Ge_{1.5}(PO₄)₃, LGAP), and an ink vehicle (by Fuelcellmaterials Company) were mixed to obtain a composition for forming a composite. In the composition for forming the composite, the mixing weight ratio of the cathode active material of Preparation Example 1, the crystalline solid electrolyte (Li_{1.5}Al_{0.5}Ge_{1.5}(PO₄)₃), and the ink vehicle was 1:1:2.

As a solid electrolyte layer, solid electrolyte (Li_{1.5}Al_{0.5}Ge_{1.5}(PO₄)₃) pellets having a thickness of 900 µm were prepared. Then, the composition for forming a composite was coated on the solid electrolyte layer and then the resulting product was subjected to heat treatment at a temperature of 700° C. under pressure of 125 MPa, thereby preparing a cathode active material layer including a composite.

An aluminum foil (thickness: about 15 µm) was laminated on the other surface of the cathode active material layer, thereby preparing a composite cathode.

As a counter electrode to the composite cathode, a lithium metal electrode was used, thereby preparing a 2032-type coin cell. A separator (thickness: about 16 µm) made of a porous polyethylene (PE) film was arranged between the composite cathode and the lithium metal electrode, and then, an electrolyte was injected thereto to prepare a lithium secondary battery in the form of a 2032-type coin cell. For use as the electrolyte, a solution in which 1 M LiPF₆ was dissolved in a solvent, i.e., propylene carbonate (PC) was used.

### Examples 2 and 3

Composite cathodes and lithium secondary batteries were respectively prepared in the same manner as in Example 1, except that the mixing weight ratio of the cathode active material (Li₃V₂(PO₄)₃) of Preparation Example 1 and the solid electrolyte (Li_{1.5}Al_{0.5}Ge_{1.5}(PO₄)₃) was changed to 1:0.2 (Example 2) and 1:20 (Example 3).

### Examples 4 and 5

Composite cathodes and lithium secondary batteries were respectively prepared in the same manner as in Example 1, except that, in the preparation of a cathode, LiFePO₄ of Preparation Example 2 and LiCoPO₄ of Preparation Example 3 were respectively used instead of the cathode active material (Li₃V₂(PO₄)₃) of Preparation Example 1.

### Comparative Example 1

A cathode and a lithium secondary battery were prepared in the same manner as in Example 1, except that a cathode was prepared according to the following procedure.

The crystalline phosphate-based cathode active material (Li₃V₂(PO₄)₃, LVP) of Preparation Example 1, a crystalline solid electrolyte (Li_{1.5}Al_{0.5}Ge_{1.5}(PO₄)₃, LGAP), and an ink vehicle (by Fuelcellmaterials Company) were mixed to obtain a composition for forming a composite. In the composition for forming a composite, the mixing weight ratio of the cathode active material of Preparation Example 1, the crystalline solid electrolyte (Li_{1.5}Al_{0.5}Ge_{1.5}(PO₄)₃), and the ink vehicle was 1:1:2.

As a solid electrolyte layer, solid electrolyte (Li₁.₅Al₀.₅Ge₁.₅(PO₄)₃) pellets having a thickness of 900 µm were prepared. Then, the composition for forming a composite was coated on the solid electrolyte layer to form a composite, and the composite was subjected to heat treatment at a temperature of 600° C. under pressure of 125 MPa, thereby preparing a cathode active material layer.

An aluminum foil (thickness: about 15 µm) was laminated on the other surface of the cathode active material layer, thereby preparing a cathode.

### Comparative Example 2

A cathode and a lithium secondary battery were prepared in the same manner as in Comparative Example 1, except that the heat treatment was performed at a temperature of 650° C. instead of 600° C. in the preparation of the cathode active material layer.

### Comparative Example 3

A cathode and a lithium secondary battery were prepared in the same manner as in Comparative Example 1, except that a cathode was prepared according to the following procedure.

The crystalline phosphate-based cathode active material (Li₃V₂(PO₄)₃, LVP) of Preparation Example 1, a crystalline solid electrolyte (Li_{1.5}Al_{0.5}Ge_{1.5}(PO₄)₃, LGAP), and an ink vehicle (by Fuelcellmaterials Company) were mixed to obtain a composition for forming a composite. In the composition for forming a composite, the mixing weight ratio of the cathode active material of Preparation Example 1, the solid electrolyte (Li_{1.5}Al_{0.5}Ge_{1.5}(PO₄)₃), and the ink vehicle was 1:1:2.

As a solid electrolyte layer, solid electrolyte (Li_{1.5}Al_{0.5}Ge_{1.5}(PO₄)₃) pellets having a thickness of 900 µm were prepared. Then, the composition for forming a composite was coated on the solid electrolyte layer, and then the resulting product was subjected to heat treatment at a temperature of 600° C. under pressure of 125 MPa for 30 minutes, thereby preparing a cathode active material layer.

An aluminum foil (thickness: about 15 µm) was laminated on the other surface of the cathode active material layer, thereby preparing a cathode.

### Comparative Example 4

A cathode and a lithium secondary battery were prepared in the same manner as in Comparative Example 1, except that a cathode was prepared according to the following procedure.

The cathode active material of Preparation Example 1, a solid electrolyte (Li_{1.5}Al_{0.5}Ge_{1.5}(PO₄)₃), Denka black (DB), and an ink vehicle (by Fuelcellmaterials Company) were mixed to obtain a composition for forming a cathode active material layer. In the composition for forming a cathode active material layer, the mixing weight ratio of the cathode active material of Preparation Example 1, the solid electrolyte (Li_{1.5}Al_{0.5}Ge_{1.5}(PO₄)₃), and the ink vehicle was 1:1:2, and in the composition for forming the cathode active material layer, a mixed weight ratio of the cathode active material of Preparation Example 1, the solid electrolyte (Li_{1.5}Al_{0.5}Ge_{1.5}(PO₄)₃), and DB was 49:49:2.

As a solid electrolyte layer, solid electrolyte (Li_{1.5}Al_{0.5}Ge_{1.5}(PO₄)₃) pellets having a thickness of 900 µm were prepared. Then, the composition for forming a cathode active material layer was coated on the solid electrolyte layer, and then the resulting product was subjected to heat treatment at a temperature of 700° C. under pressure of 125 MPa for 30 minutes, thereby preparing a cathode active material layer.

An aluminum foil (thickness: about 15 µm) was laminated on the other surface of the cathode active material layer, thereby preparing a cathode.

### Comparative Example 5

A cathode and a lithium secondary battery were prepared in the same manner as in Comparative Example 1, except that a cathode was prepared according to the following procedure.

The cathode active material of Preparation Example 1, a solid electrolyte (Li_{1.5}Al_{0.5}Ge_{1.5}(PO₄)₃), and an ink vehicle (by Fuelcellmaterials Company) were mixed to obtain a composition for forming a cathode active material layer. In the composition for forming a cathode active material layer, the mixing weight ratio of the cathode active material of Preparation Example 1, the solid electrolyte (Li_{1.5}Al_{0.5}Ge_{1.5}(PO₄)₃), and the ink vehicle was 1:1:2.

As a solid electrolyte layer, a solid electrolyte (Li_{1.5}Al_{0.5}Ge_{1.5}(PO₄)₃) film having a thickness of 900 µm was prepared. Then, the composition for forming a cathode active material layer was coated on the solid electrolyte layer, and then the resulting product was subjected to heat treatment at 700° C. under no pressure for 2 hours, thereby preparing a cathode active material layer including the composite.

An aluminum foil (thickness: about 15 µm) was laminated on an untreated surface of the cathode active material layer, thereby preparing a cathode.

### Evaluation Example 1: Scanning Electron Microscopy

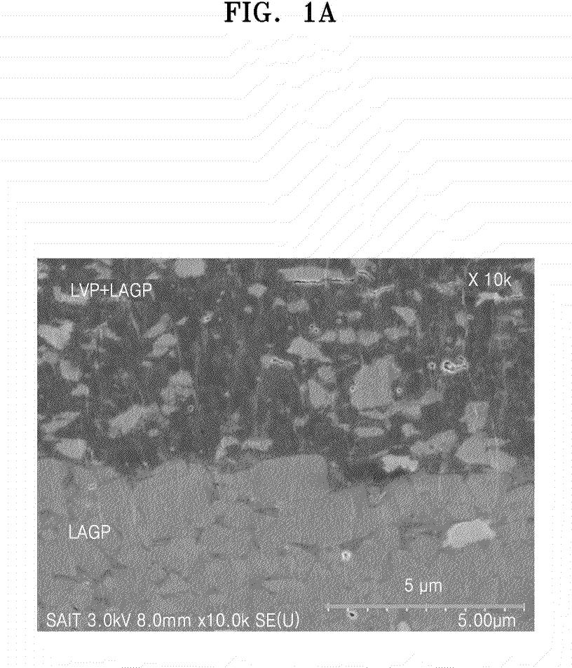

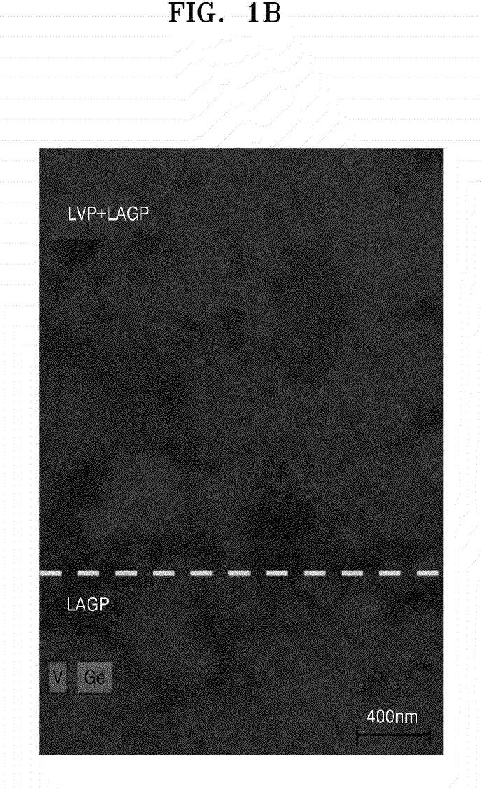

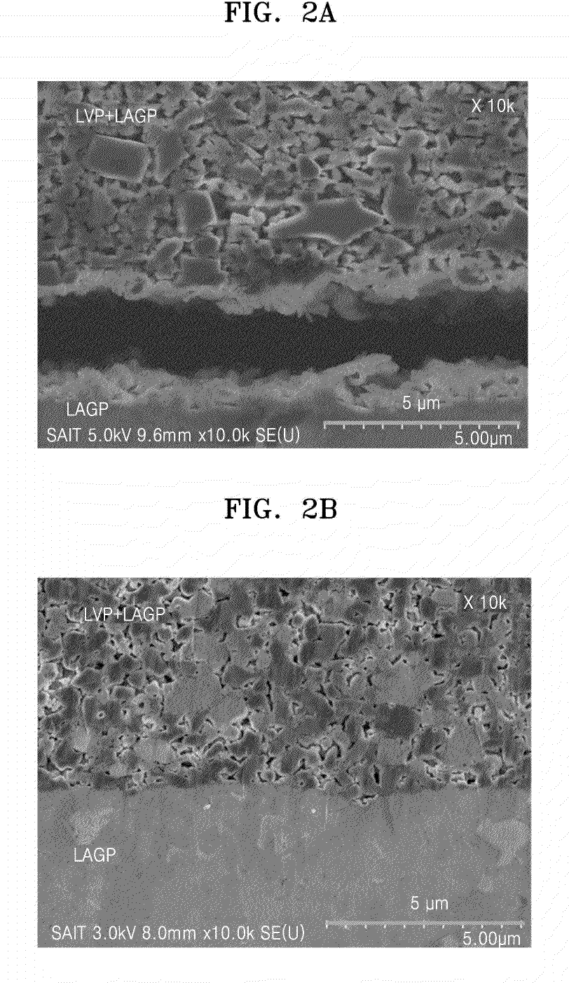

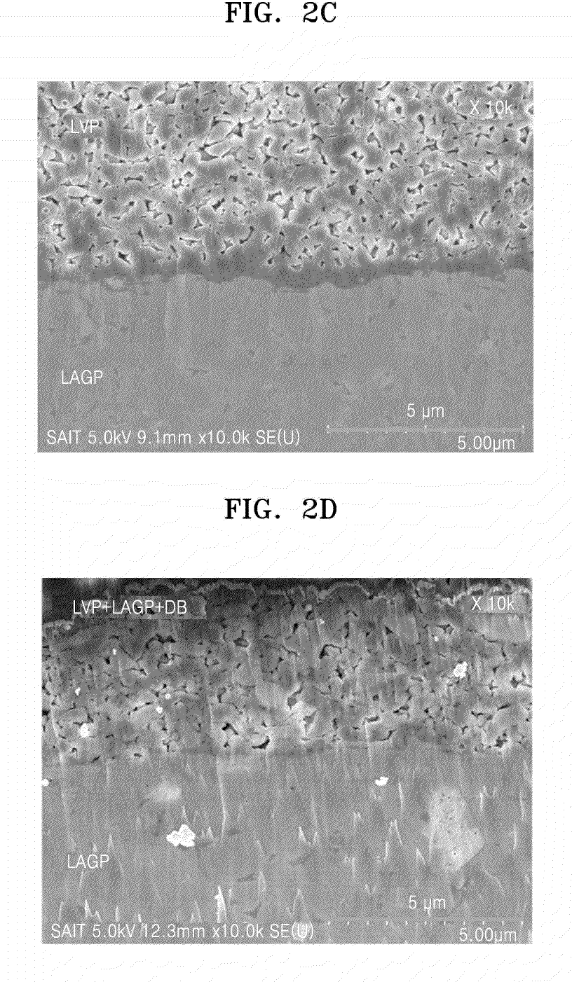

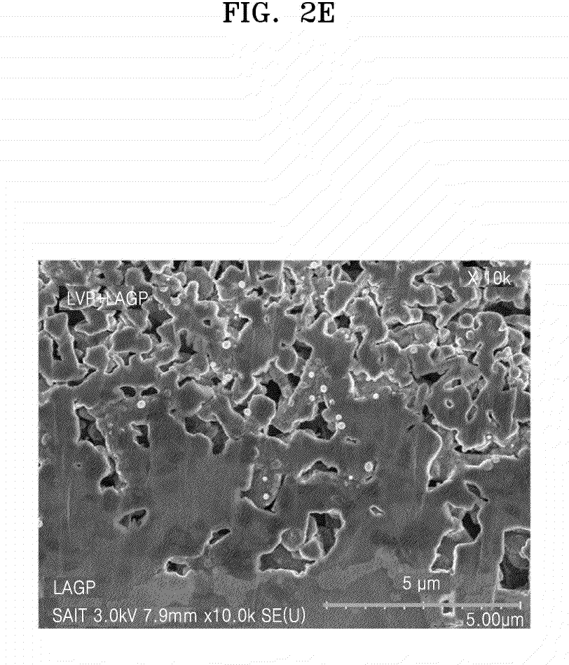

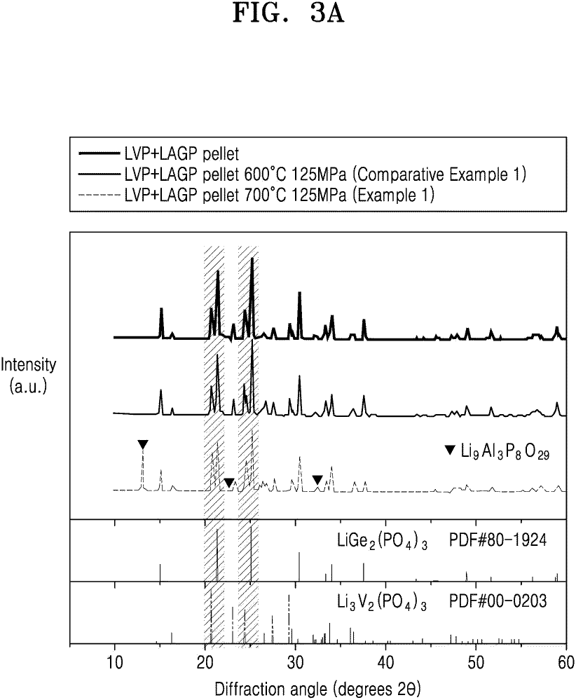

For the composites of Example 1 and Comparative Examples 1 to 5, scanning electron microscopy (SEM) analysis was performed, and results thereof are respectively shown in FIG. 1A and FIGS. 2A to 2D.

Referring to FIG. 1A, the composite cathode of Example 1 included a composite having a densified structure by which the cathode active material LVP and the solid electrolyte LAGP formed an interphase, and an interfacial surface between the cathode and the solid electrolyte was dense and uniform. In the composite, the cathode active material LVP partially surrounded the solid electrolyte LAGP. Although not shown in FIG. 1A, the composite had a structure in which the cathode active material LVP completely surrounded the solid electrolyte LAGP.

As shown in FIG. 2A, unlike the case of Example 1, the cathode of Comparative Example 1 that was heat-treated at 600° C. had many pores formed in the interfacial surface between the cathode and the solid electrolyte, and had a cathode that was not densified unlike the composite cathode of Example 1. In addition, as shown in FIG. 2B, the cathode of Comparative Example 2 that was heat-treated at 650° C. had a cathode that was not densified unlike the composite cathode of Example 1.

The cathode of Comparative Example 3 was formed by using the cathode active material LVP only, and had a cathode that was not densified as shown in FIG. 2C. Unlike the case of Example 1, an interphase was not formed between the cathode and the solid electrolyte Li_{1.5}Al_{0.5}Ge_{1.5}(PO₄)₃ (LAGP).

The cathode of Comparative Example 4 was prepared by using Denka black (DB) which is a carbon-based compound to improve the electrical conductivity, but had a structure that was not densified unlike the composite cathode of Example 1 as shown in FIG. 2D. In addition, the cathode of Comparative Example 5 did not undergo a pressurization process in the preparation of the cathode, and accordingly, had a structure that was not densified as shown in FIG. 2E.

In addition, a porosity of the composite cathode of Example 1 and the cathodes of Comparative Examples 1 to 5 were evaluated, and results thereof are shown in Table 2. Here, the porosity was evaluated by SEM, and results thereof are shown in Table 2.

TABLE 2

| Division | Porosity (%) |
|---|---|
| Example 1 | 0.82 |
| Comparative Example 1 | 15.42 |
| Comparative Example 2 | 9.81 |
| Comparative Example 3 | 11.40 |
| Comparative Example 4 | 6.13 |
| Comparative Example 5 | 21.63 |

Referring to Table 2, the composite cathode of Example had a densified structure with a porosity of 0.82 %, whereas the cathodes of Comparative Examples 1 to 5 each had a porosity of greater than 6.13 %. Thus, it was confirmed that the cathodes of Comparative Examples 1 to 5 each had a porous structure that was not densified compared to the composite cathode of Example 1.

### Evaluation Example 2: X-Ray Diffraction (XRD) Analysis (I)

For the composite cathode including the composite of Example 1 and the cathode including the composite of Comparative Example 1, an XRD analysis was performed. Here, the XRD analysis was performed by using a X'pert pro diffractometer (PANalytical) using Cu Ka radiation (1.54056 Â).

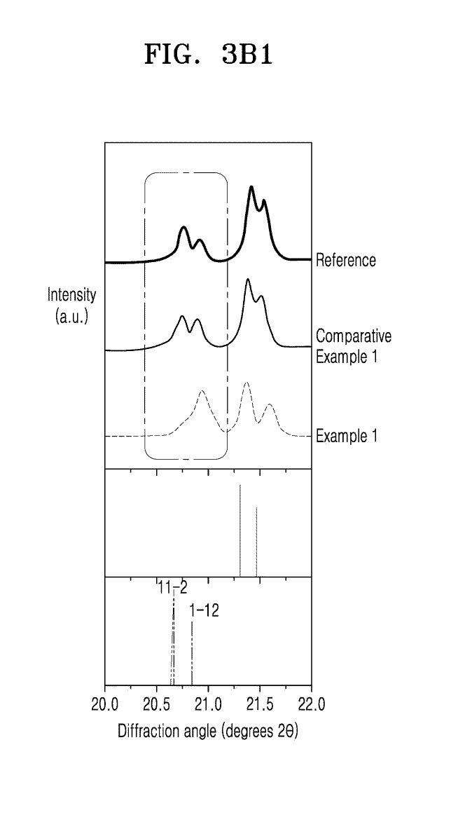

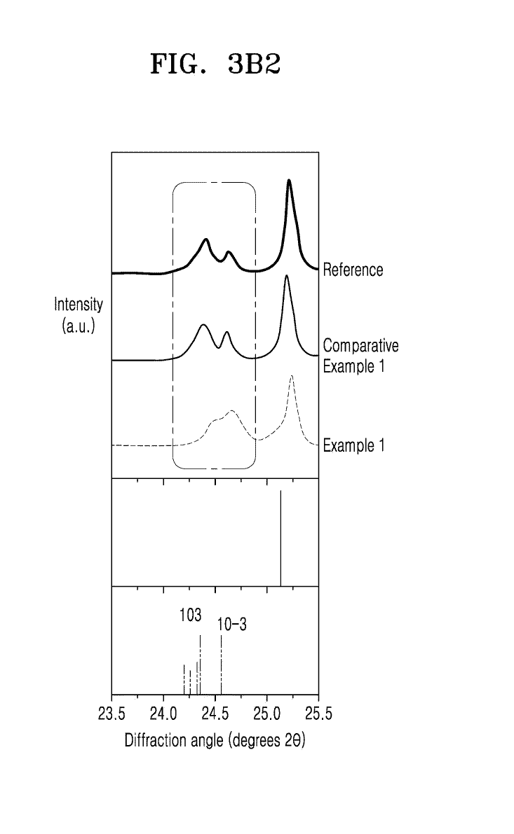

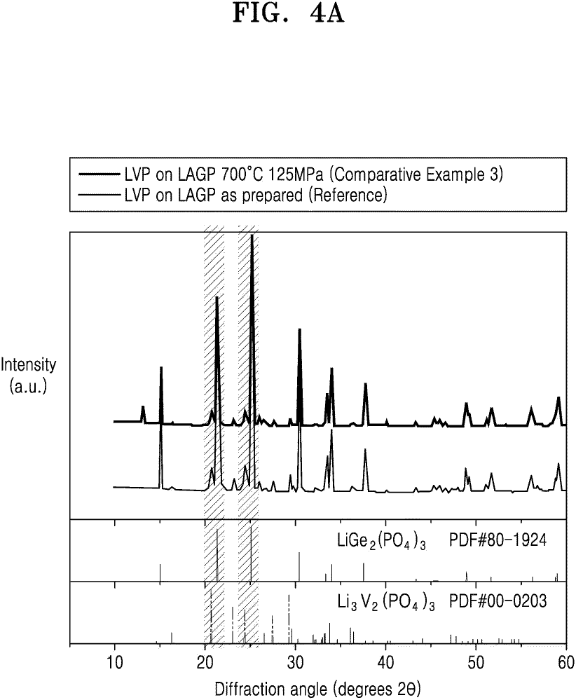

FIG. 3A shows results of the XRD analysis, and FIGS. 3B1 and 3B2 show enlarged views of a partial region of FIG. 3A. In FIG. 3A, 3B1 and 3B2, LiGe₂(PO₄)₂ and Li₃V₂(PO₄)₃ were used as reference.

A I(₁₁₋₂) peak which appears in a region at a diffraction angle (2θ) of 20.69±0.1°2θ, a I(₁₋₁₂) peak which appears in a region at a diffraction angle of 20.9±0.1°2θ, a I(₁₀₋₃) peak which appears in a region at a diffraction angle of 24.7±0.1°2θ, and a I(₁₀₃) peak which appears in a region at a diffraction angle of 24.4±0.1°2θ, all gave information about the change in the lattice constant due to the distortion of the crystal structure of Li₃V₂(PO₄)₃ (LVP), wherein the diffraction angle was obtained by performing XRD analysis using a CuKa radiations on the composite.

In this regard, it was confirmed that, when the heat treatment under pressure was performed at a temperature of 700° C. and a pressure of 125 MPa during the preparation of the composite cathode according to Example 1, an XRD peak intensity ratio of the cathode active material LVP was changed.

Comparative Example 1 showed the characteristics of I(₁₁₋₂) > I(₁₋₁₂) and I(₁₀₃) > I(₁₀₋₃), whereas Example 1 showed the characteristics of I(₁₁₋₂) < I(₁₋₁₂) and I(₁₀₃) < I(₁₀-₃).

Table 3 showed the measurements of I(₁₁₋₂)/I(₁₋₁₂) and I(₁₀₃)/I(₁₀₋₃).

TABLE 3

| Division | l(₁₁-₂)/l(₁-₁₂) | I(₁₀₃)/I(₁₀₋₃) |
|---|---|---|
| Example 1 | 0.12 | 0.27 |
| Comparative Example 1 | 1.10 | 1.35 |

Referring to Table 3, it was confirmed that I(₁₁₋₂)/I(₁₋₁₂) and I(₁₀₃)/I(₁₀-₃) with respect to the composite cathode including the composite of Example 1 were each a value less than 1, whereas I(₁₁₋₂)/I(₁₋₁₂) and I(₁₀₃)/I(₁₀-₃) with respect to the composite cathode including the composite of Comparative Example 1 were each a value greater than 1.

### Evaluation Example 3: XRD Analysis (II)

The XRD analysis was performed on the cathode including the composite of Comparative Example 3. Here, the XRD analysis was performed by using a X’pert pro diffractometer (PANalytical) using Cu Ka radiation (1.54056 Å).

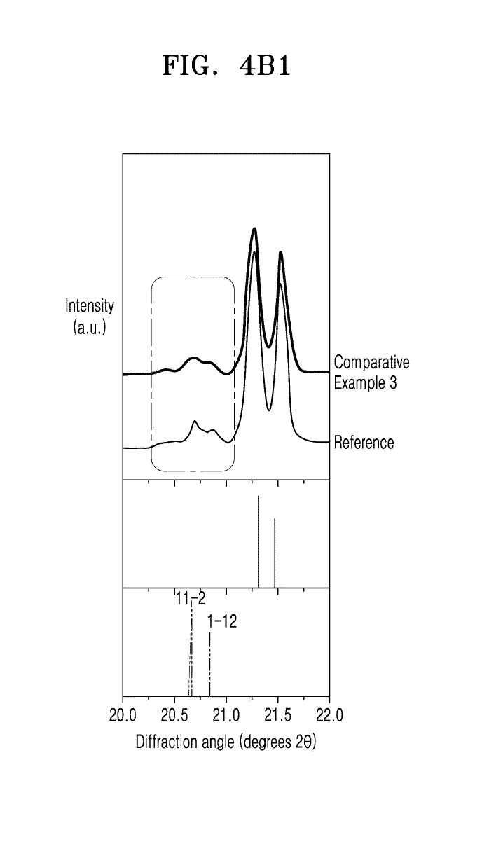

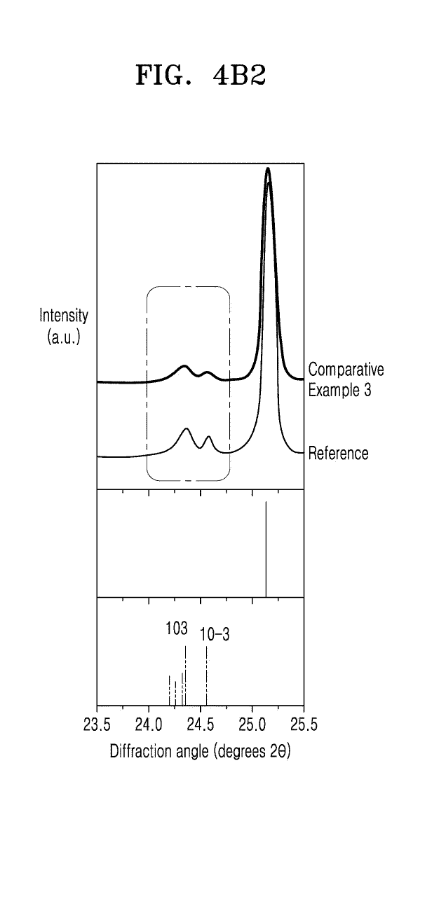

FIG. 4A shows results of the XRD analysis, and FIGS. 4B1 and 4B2 show an enlarged views of a partial region of FIG. 4A. FIG. 4A, 4B1 and 4B2 show the analysis results obtained by reference groups in a state before the heat treatment was performed according to Example 1.

In this regard, it was confirmed that, even under the same conditions of 700° C. and 125 MPa according to Comparative Example 3, the XRD peak intensity reversal phenomenon of the cathode active material LVP observed in the composite cathode of Example 1 did not occur in the electrode formed by using only the cathode active material LVP without the solid electrolyte LAGP.

### Evaluation Example 4: EDS Analysis

The EDS analysis was performed on the composite cathode of Example 1, and results thereof are shown in FIG. 1B.

Referring to FIG. 1B, it was confirmed in the composite cathode of Example 1 that the cathode active material LVP was in contact with the solid electrolyte LAGP through the interface, and LVP surrounded LAGP. Also, the presence of elements such as Al, O, P, and V was confirmed.

### Evaluation Example 5: Charge/Discharge Characteristics

### Examples 1 and 2 and Comparative Examples 1 to 5

The charge/discharge characteristics of the coin cells of Examples 1 and 2 and Comparative Examples 1 to 5 were evaluated by the following charge/discharge test.

Charging and discharging of each coin cell was paused at 25° C. for 5 hours, and constant current charging was performed with a current of 0.05 C until the voltage reached 4.2 volts (V). The cells that were fully charged were then subjected to constant current discharge with a current of 0.025 C until the voltage reached 3.0 V.

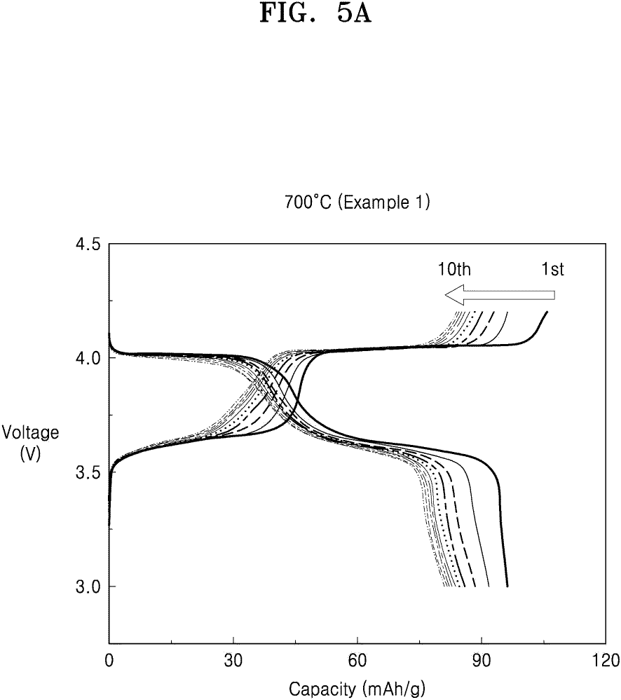

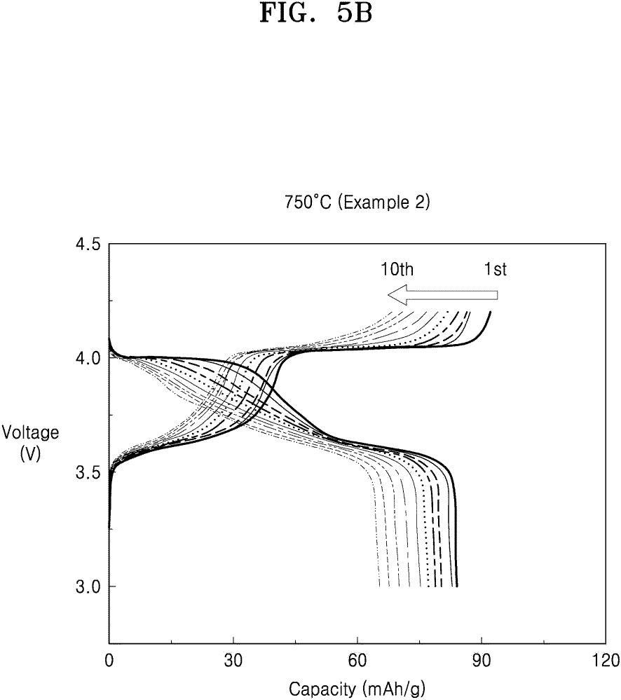

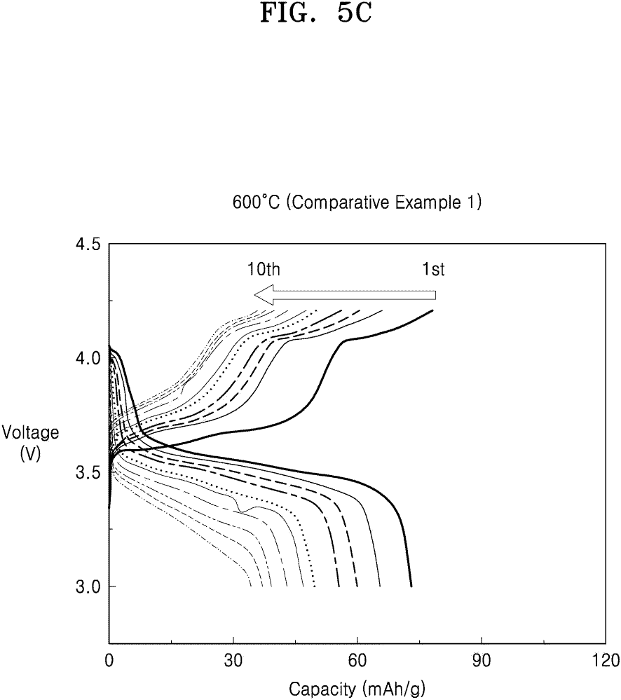

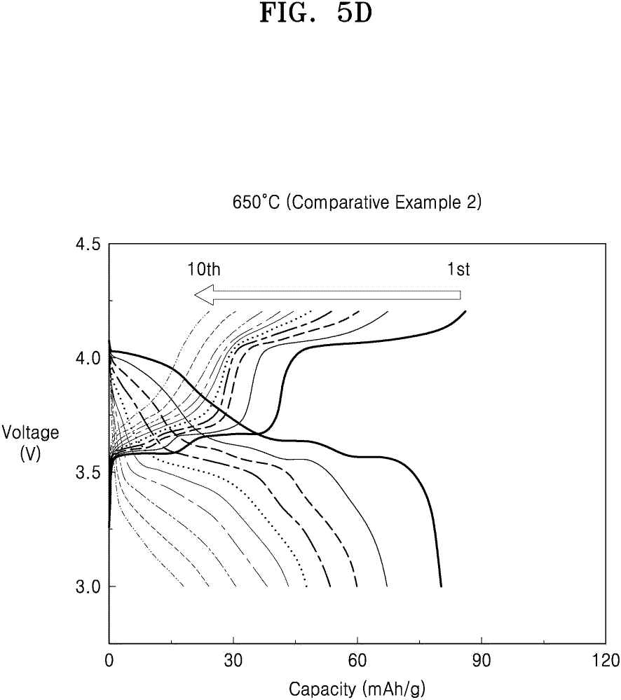

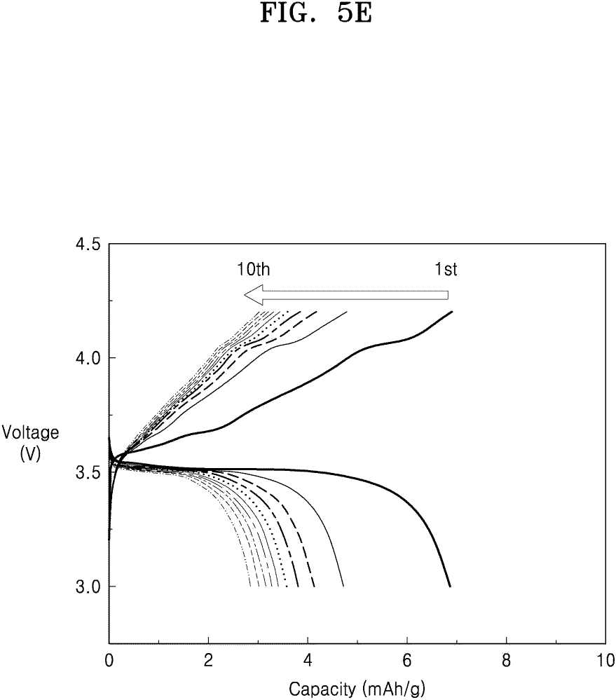

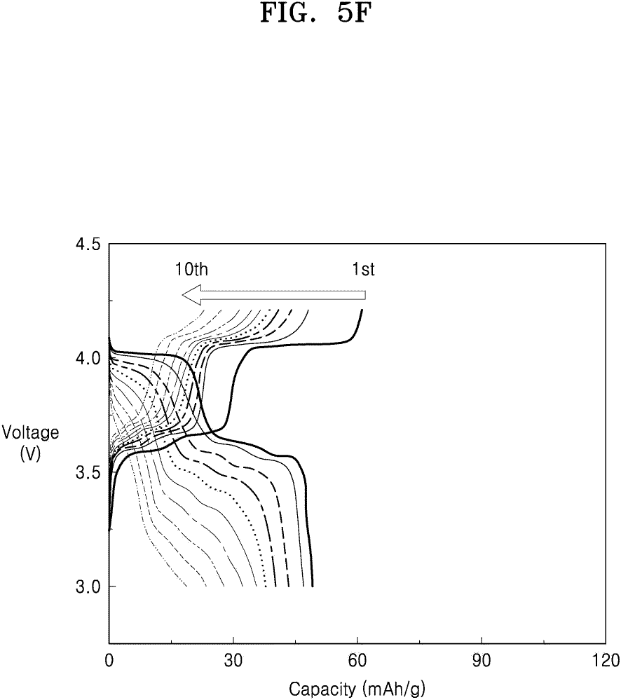

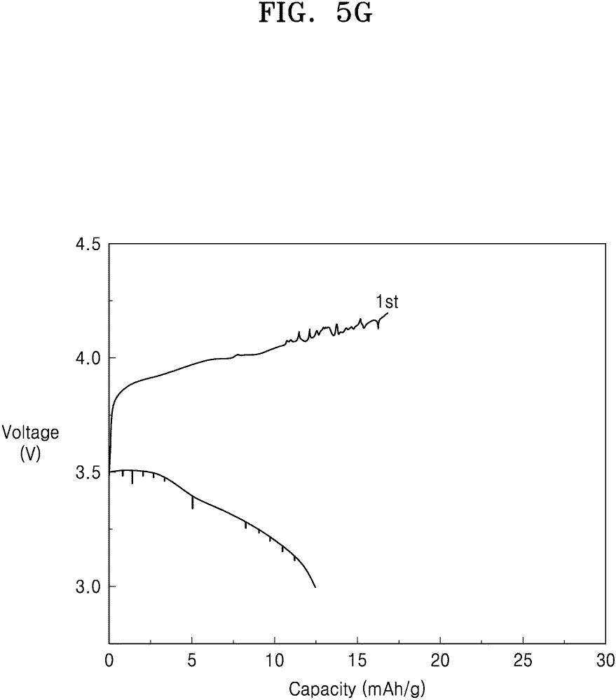

Such a charge/discharge cycle was repeated 10 times in total. Some of the charge/discharge results are shown in FIGS. 5A to 5G.

As shown in FIGS. 5A and 5B, the lithium secondary batteries of Examples 1 and 2 had high initial charge/discharge capacity and improved capacity retention according to cycles.

However, as shown in FIGS. 5C and 5D, the lithium secondary batteries of Comparative Examples 1 and 2 had low initial charge/discharge capacity at a temperature of 650° C. or less and poor capacity retention. In the cases of the cathode of Comparative Example 3 prepared by using LVP only, the cathode of Comparative Example 4 prepared by adding DB, and the cathode of Comparative Example 5 prepared without pressurization, the initial charge/discharge capacity thereof was low as shown in FIGS. 5E, 5F, and 5G, respectively. Also, referring to FIG. 5F, it was confirmed that the cathode of Comparative Example 4 had improved electrical conductivity by the addition of the carbon-based compound such as DB, but poor charge/discharge characteristics because a dense LVP-LAGP interface was not formed.

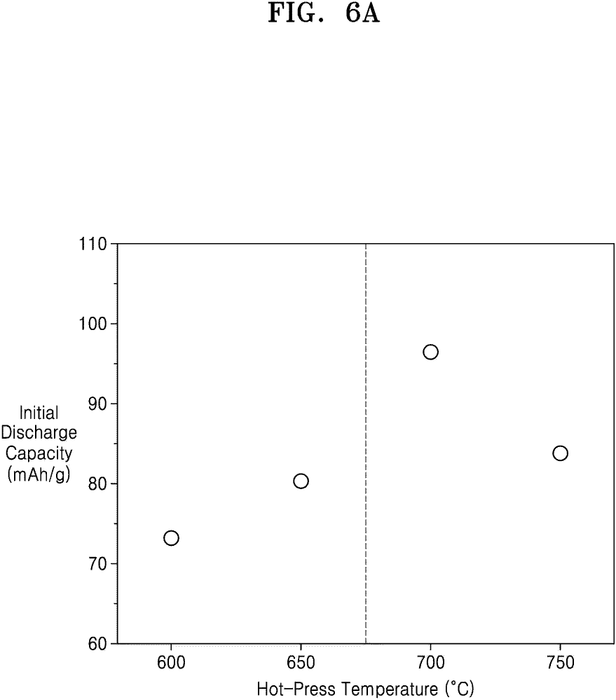

Based on these results, the changes in the initial discharge according to the heat treatment temperature during the preparation of the cathode and changes in capacity retention after performing 10 cycles of the charge/discharge were investigated, and results are shown in FIGS. 6A and 6B.

Referring to FIGS. 6A and 6B, the initial charge/discharge capacity was high when the heat treatment was performed at a temperature in a range of about 700° C. to about 750° C. and that the capacity retention was improved.

In addition, regarding the lithium secondary batteries of Examples 3 to 5, the initial charge/discharge capacity and the capacity retention were evaluated in the same manner as in the way of evaluating the charge/discharge characteristics of the lithium secondary battery of Example 1.

As a result of the evaluation, it was confirmed that the lithium secondary batteries of Examples 3 to 5 had the initial charge/discharge capacity and the capacity retention at equivalent levels of those of the lithium secondary battery of Example 1.

According to the one or more embodiments, a composite cathode has a dense structure by which cathode active materials having high conductivity form an electronic conduction pathway to be connected to each other. When such a composite cathode is used, an interface between a cathode and a solid electrolyte may be easily formed, thereby reducing interfacial resistance therebetween. Also, a secondary battery having high initial capacity and improved cycle stability may be prepared by using the composite cathode according to an embodiment.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite cathode comprising:
a cathode current collector; and
a cathode active material layer on the cathode current collector, wherein the cathode active material layer comprises a composite comprising
a crystalline phosphate solid electrolyte;
a crystalline phosphate cathode active material having an electrical conductivity that is about 10 times to about 10⁶ times greater than an electrical conductivity of the crystalline phosphate solid electrolyte; and
an interphase between the crystalline phosphate solid electrolyte and the crystalline phosphate cathode active material.

2. The composite cathode of claim 1, wherein a total content of the interphase is less than a total content of the crystalline phosphate solid electrolyte and the crystalline phosphate cathode active material.

3. The composite cathode of claim 1, wherein the crystalline phosphate cathode active material has an electrical conductivity that is about 10² times to about 10³ times greater than an electrical conductivity of the crystalline phosphate solid electrolyte.

4. The composite cathode of claim 1, wherein the interphase is amorphous, and
the interphase comprises at least one element which is also comprised in the crystalline phosphate solid electrolyte, the crystalline phosphate cathode active material, or a combination thereof.

5. The composite cathode of claim 1, wherein, in the composite, the crystalline phosphate cathode active material is disposed on a surface of the crystalline phosphate solid electrolyte, and
the interphase is disposed between the crystalline phosphate solid electrolyte and the crystalline phosphate cathode active material.

6. The composite cathode of claim 1, wherein the crystalline phosphate cathode active material is a compound represented by Formula 1, a compound represented by Formula 2, or a combination thereof:
Formula 1 LiₘMₐ(PO₄)₃
wherein, in Formula 1, M is Ti, Si, Mn, Fe, Co, V, Cr, Mo, Ni, Al, Mg, Al, or a combination thereof, and
1≤m≤5 and 1≤a≤2; and
Formula 2 LiₙM1(PO₄)
wherein, in Formula 2, M1 is Co, Ni, Mn, Fe, or a combination thereof, and 1≤n≤1.5.

7. The composite cathode of claim 6, wherein the crystalline phosphate cathode active material is Li₃V₂(PO₄)₃, LiCoPO₄, LiFePO₄, LiNiPO₄, LiMnPO₄, or a combination thereof.

8. The composite cathode of claim 1, wherein the crystalline phosphate solid electrolyte is Li+₁₊ₓAlₓGe₂₋ₓ(PO₄)₃ wherein 0<x≤2, Li₁+ₓAlₓTi₂₋ₓ(PO₄)₃ wherein 0≤x≤1, Li₁+ₓ+_{y}AlₓTi₂₋ₓSi_{y}P_{3-y}O₁₂ wherein 0<x<2 and 0≤y<3, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li₁+ₓ+_{y}(AlₐGa₁₋ₐ)ₓ(Ti_{b}Ge_{1-b})₂₋ₓSi_{y}P_{3-y}O₁₂ wherein 0<a<1, 0<b<1, 0≤x≤1, and 0≤y≤1, or a combination thereof.

9. The composite cathode of claim 1, wherein the crystalline phosphate solid electrolyte is Li_{1.5}Al_{0.5}Ge₁.₅(PO₄)₃, Li_{1.3}Al_{0.3}Ge_{1.7}(PO₄)₃, Li_{1.3}Al_{0.3}Ti_{1.7}(PO₄)₃, or a combination thereof.

10. The composite cathode of claim 1, wherein an amount of the crystalline phosphate solid electrolyte is in a range of about 0.2 parts by weight to about 20 parts by weight, based on 1 part by weight of the crystalline phosphate cathode active material.

11. The composite cathode of claim 1, wherein a ratio of a peak intensity of an I(₁₁₋₂) peak to a peak intensity of an I(₁₋₁₂) peak of the composite is less than 1, wherein the I(₁₁₋₂) peak appears at a diffraction angle of 20.69±0.1 °2θ and the I(₁₋₁₂) peak appears at a diffraction angle of 20.9±0.1 °2θ, when analyzed by X-ray diffraction using a CuKα radiation.

12. The composite cathode of claim 1, wherein a ratio of a peak intensity of an I(₁₀₃) peak to a peak intensity of an I(₁₀₋₃) peak of the composite is less than 1, wherein the I(₁₀₃) peak appears at a diffraction angle of 24.4±0.1 °2θ and the I(₁₀₋₃) peak appears at a diffraction angle of 24.7±0.1 °2θ, when analyzed by X-ray diffraction using a CuKα radiation.

13. The composite cathode of claim 1, wherein the composite has a porosity in a range of about 0.1 percent to about 5 percent, based on a total volume of the composite, and the composite comprises closed pores.

14. The composite cathode of claim 1, wherein the composite cathode is free of an electron conductor other than the crystalline phosphate cathode active material or the crystalline phosphate solid electrolyte.

15. A secondary battery comprising:
the composite cathode of claim 1;
an anode; and
an electrolyte between the composite cathode and the anode.

16. The secondary battery of claim 15, wherein the secondary battery is a lithium secondary battery or an all-solid-state battery.

17. The secondary battery of claim 16, wherein the all-solid-state battery is a multilayer-ceramic battery or a thin film battery.

18. The secondary battery of claim 17, wherein the multilayer-ceramic battery comprises a cell unit comprising:
a cathode layer comprising a cathode active material layer;
a solid electrolyte layer; and
an anode layer comprising an anode active material layer, wherein the solid electrolyte layer is between the cathode layer and the anode layer, and comprises a laminate structure comprising a plurality of the cell units disposed such that the cathode active material layer of a first cell faces the anode active material layer of an adjacent cell.

19. The secondary battery of claim 17, wherein the multilayer-ceramic battery comprises a laminate comprising a plurality of the cell units, each cell unit comprising a cathode active material layer, a solid electrolyte layer, and an anode active material layer, wherein the solid electrolyte layer is between the cathode layer and the anode layer, and disposed such that the cathode active material layer of a first cell faces the anode active material layer of an adjacent cell.

20. The secondary battery of claim 15, wherein the secondary battery comprises: a cathode layer comprising a cathode active material layer; an anode layer comprising an anode current collector layer, and either of a first anode active material layer or a third anode active material layer; and a solid electrolyte layer between the cathode layer and the anode layer.

21. A method of preparing a composite cathode, the method comprising:
mixing a crystalline phosphate solid electrolyte, a crystalline phosphate cathode active material having an electrical conductivity about 10 times to about 10⁶ times greater than an electrical conductivity of the crystalline phosphate solid electrolyte, a binder, and a solvent to provide a composition; and
heat treating the composition at a temperature of about 700° C. or greater and at a pressure of about 150 megapascals or less to form the composite cathode of claim 1.

22. The method of claim 21, wherein the heat treating comprises heat treating at a temperature in a range of about 700° C. to about 800° C. and at a pressure in a range of about 50 megapascals to about 125 megapascals.

23. The method of claim 21, wherein an amount of the crystalline phosphate solid electrolyte is in a range of about 0.2 parts by weight to about 20 parts by weight, based on 1 part by weight of the crystalline phosphate cathode active material.
